(19) United States
(12) Patent Application Publication
(10) Pub. No.: US 2016/0009998 A1
(43) Pub. Date: Jan. 14, 2016

(54) LIQUID CRYSTAL COMPOSITION AND LIQUID CRYSTAL DISPLAY DEVICE

(71) Applicants: JNC CORPORATION, TOKYO (JP); JNC PETROCHEMICAL CORPORATION, TOKYO (JP)

(72) Inventors: MASAYUKI SAITO, CHIBA (JP); YOSHIMASA FURUSATO, CHIBA (JP)

(21) Appl. No.: 14/566,711

(22) Filed: Dec. 11, 2014

(30) Foreign Application Priority Data
Jul. 9, 2014 (JP) 2014-141386
Dec. 4, 2014 (JP) 2014-245550

(51) Int. Cl. C09K 19/30; C09K 19/54

(52) U.S. Cl. CPC C09K 19/3098; C09K 19/3066; C09K 19/542; C09K 2019/548

(57) ABSTRACT

A liquid crystal composition and an AM device containing the liquid crystal composition are described. The liquid crystal composition has a negative dielectric anisotropy, and includes a specific compound having a large optical anisotropy and a small viscosity as a first component, a specific compound having a small viscosity as a second component, and a specific compound having a large optical anisotropy as a third component. The composition may further include a specific compound having a high maximum temperature as a fourth component, a specific compound having a negative dielectric anisotropy as a fifth component, and/or a specific compound having a polymerizable group as an additive component.

### CROSS-REFERENCE TO RELATED APPLICATION

This application claims the priority benefit of Japan application serial no. 2014-141386, filed on Jul. 9, 2014, and Japan application serial no. 2014-245550, filed on Dec. 4, 2014. The entirety of each of the above-mentioned patent applications is hereby incorporated by reference herein and made a part of this specification.

### TECHNICAL FIELD

The invention relates to a liquid crystal composition, a liquid crystal display (LCD) device comprising this composition, and so forth. The invention particularly relates to a liquid crystal composition having a negative dielectric anisotropy, and an LCD device comprising this composition and having a mode such as IPS, VA, FFS or FPA. The invention also relates to an LCD device of a polymer sustained alignment (PSA) type.

### TECHNICAL BACKGROUND

For LCD devices, a classification based on the operating mode of liquid crystal molecules includes modes such as PC (phase change), TN (twisted nematic), STN (super twisted nematic), ECB (electrically controlled birefringence), OCE (optically compensated bend), IPS (in-plane switching), VA (vertical alignment), FFS (fringe field switching) and FPA (field-induced photo-reactive alignment). A classification based on the driving mode of the device includes PM (passive matrix) and AM (active matrix) types. The PM types are classified into static type, multiplex type and so forth, and the AM types are classified into TFT (thin film transistor) type, MIM (metal-insulator-metal) type and so forth. The TFT type is further classified into amorphous silicon type and polycrystal silicon type, wherein the latter type is classified into high-temperature type and low-temperature type depending on the production process. A classification based on the light source includes a reflection type utilizing natural light, a transmission type utilizing a backlight, and a semi-transmission type utilizing both natural light and a backlight.

The LCD device comprises a liquid crystal composition having a nematic phase. This composition has suitable characteristics. An AM device having good characteristics can be achieved by improving the characteristics of the composition. Table 1 below summarizes the relationship between these two groups of characteristics. The characteristics of the composition will be further explained on the basis of a commercially available AM device. The temperature range of a nematic phase relates to the temperature range in which the device can be used. A desirable maximum temperature of the nematic phase is about 70° C. or higher and a desirable minimum temperature of the same is about −10° C. or lower. The viscosity of the composition relates to the response time of the device. A short response time is desirable for displaying moving images on the device. A response time that is one millisecond shorter than that of other devices is desirable. Thus a small viscosity of the composition is desirable. A small viscosity at a low temperature is more desirable.

TABLE 1
Characteristics of Compositions and AM Devices

| | Characteristics of | |
|---|---|---|
| No. | Compositions | Characteristics of AM Devices |
| 1 | Wide temperature range of a | Wide temperature range in which |
| | nematic phase | the device can be used |
| 2 | Small viscosity | Short response time |
| 3 | Suitable optical anisotropy | Large contrast ratio |
| 4 | Large positive or large | Low threshold voltage, |
| | negative dielectric | low power consumption, and |
| | anisotropy | large contrast ratio |
| 5 | Large specific resistance | Large voltage holding ratio, and |
| | | large contrast ratio |
| 6 | High stability to UV light and | Long service life |
| | heat | |

The optical anisotropy of the composition relates to the contrast ratio of the device. A large optical anisotropy or a small optical anisotropy, namely a suitable optical anisotropy, is necessary depending on the mode of the device. The product (Δn×d) of the optical anisotropy (Δn) of the composition and the cell gap (d) of the device is designed so as to maximize the contrast ratio. A suitable value of the product depends on the type of the operating mode. This value is in the range of about 0.30 μm to about 0.40 μm for a device of a VA mode, and in the range of about 0.20 μm to about 0.30 μm for a device of an IPS or FFS mode. In these cases, a composition having a large Δn is desirable for a device having a small cell gap. A large dielectric anisotropy of the composition contributes to a low threshold voltage, low power consumption and a large contrast ratio of the device. A large dielectric anisotropy (Δ∈) is thus desirable. A large specific resistance of the composition contributes to a large voltage holding ratio and a large contrast ratio of the device. It is thus desirable that a composition should have a large specific resistance at a temperature close to the maximum temperature of nematic phase as well as at room temperature in an initial stage. It is desirable that a composition should have a large specific resistance at a temperature close to the maximum temperature of nematic phase as well as at room temperature, after it has been used for long time. The stability of the composition to UV light and heat relates to the service life of the device. The device has a long service life when the stability is high. Such characteristics are desirable for an AM device used for a liquid crystal projector, a liquid crystal TV and so forth.

A liquid crystal composition comprising a polymer is used for an LCD device of a PSA type. First, a composition to which a small amount of a polymerizable compound has been added is poured into a device. Next, the composition is irradiated with UV light, while a voltage is applied between the substrates of this device, to polymerize the polymerizable compound and give a network structure of a polymer in the composition. In this composition, the polymer makes it possible to adjust the orientation of liquid crystal molecules, and thus the response time of the device is decreased and image burn-in is reduced. Such effect of the polymer can be expected for a device having a mode such as TN, ECB, OCB, IPS, VA, FFS or FPA.

A composition having a positive Δ∈ is used for an AM device of a TN mode. A composition having a negative Δ∈ is used for an AM device of a VA mode. A composition having a positive or negative Δ∈ is used for an AM device having an IPS or FFS mode. A composition having a positive or negative Δ∈ is used for an AM device of a PSA mode. Examples of the liquid crystal composition having a negative Δ∈ are disclosed in the following Patent documents no. 1 to no. 5.

Patent document no. 1: WO 2013-122011 A.

Patent document no. 2: JP 2013-173915 A.

Patent document no. 3: WO 2012-144321 A.

Patent document no. 4: WO 2012-053323 A.

Patent document no. 5: WO 2012-046590 A.

### SUMMARY OF THE INVENTION

Accordingly, the invention provides a liquid crystal composition that satisfies at least one of characteristics such as a high maximum temperature of a nematic phase, a low minimum temperature of a nematic phase, a small viscosity, a suitable optical anisotropy, a large negative dielectric anisotropy, a large specific resistance, a high stability to UV light and a high stability to heat, or is suitably balanced between at least two of the characteristics. The invention further provides a liquid crystal display device comprising such a composition. The invention further provides an AM device that comprising such a composition and has characteristics such as a short response time, a large voltage holding ratio, a low threshold voltage, a large contrast ratio and a long service life.

The invention concerns a liquid crystal composition that has a negative dielectric anisotropy and comprises a compound represented by formula (1) as a first component, a compound represented by formula (2) as a second component, and at least one compound selected from the group consisting of compounds represented by formula (3) as a third component, wherein the proportion of the first component is in the range of 10 wt % to 25 wt % based on the weight of the liquid crystal composition. The invention also concerns a liquid crystal display device comprising this composition.

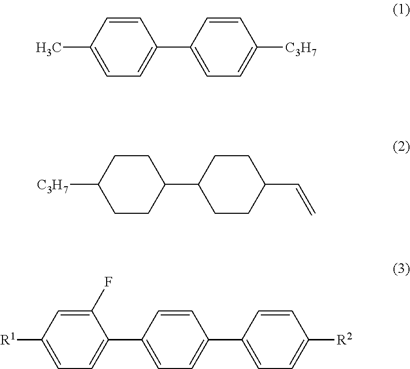

In formula (3), R¹ and R² are independently alkyl having 1 to 12 carbons, alkoxy having 1 to 12 carbons or alkenyl having 2 to 12 carbons.

With the invention, a liquid crystal composition that satisfies at least one of characteristics such as a high maximum temperature of a nematic phase, a low minimum temperature of a nematic phase, a small viscosity, a suitable optical anisotropy, a large negative dielectric anisotropy, a large specific resistance, a high stability to UV light and a high stability to heat, or is suitably balanced between at least two of the characteristics, can be provided. A liquid crystal display device comprising such a composition can also be provided. An AM device that has characteristics such as a short response time, a large voltage holding ratio, a low threshold voltage, a large contrast ratio and a long service life can also be provided.

### EMBODIMENT TO CARRY OUT THE INVENTION

The usage of the terms in the specification and claims is as follows. “Liquid crystal composition” and “liquid crystal display device” are sometimes abbreviated to “composition” and “device,” respectively. “Liquid crystal display device” is a generic term for an LCD panel and an LCD module. “Liquid crystal compound” is a generic term for a compound having a liquid crystal phase such as a nematic phase or a smectic phase, and a compound having no liquid crystal phase but being mixed to a composition for adjusting characteristics such as the temperature range of nematic phase, viscosity and Δ∈. Such compound has a 6-membered ring such as 1,4-cyclohexylene or 1,4-phenylene, and a rod-like molecular structure. “Polymerizable compound” is a compound that is added to a composition in order to form a polymer therein.

A liquid crystal composition is prepared by mixing a plurality of liquid crystal compounds. The proportion of a liquid crystal compound (content) is expressed as a weight percentage (wt %) based on the weight of this liquid crystal composition. An additive such as an optically active compound, an antioxidant, an UV light absorbent, a coloring matter, an antifoaming agent, a polymerizable compound, a polymerization initiator and a polymerization inhibitor may be added to this liquid crystal composition as required. The proportion (added amount) of the additive is expressed as a weight percentage (wt %) based on the weight of the composition as in the case of the liquid crystal compound. Weight parts per million (ppm) is sometimes used. The proportion of the polymerization initiator and the polymerization inhibitor is exceptionally expressed on the basis of the weight of the polymerizable compound.

“The higher limit of the temperature range of nematic phase” is often abbreviated to “the maximum temperature.” “A lower limit of the temperature range of nematic phase” is often abbreviated to “the minimum temperature.” That “specific resistance is large” means that the composition has a large specific resistance at a temperature close to the maximum temperature of nematic phase as well as at room temperature in an initial stage, and that the composition has a large specific resistance at a temperature close to the maximum temperature of nematic phase as well as at room temperature, after being used for long time. That “voltage holding ratio is large” means that the device has a large voltage holding ratio at a temperature close to the maximum temperature of nematic phase as well as at room temperature in an initial stage, and that the device has a large voltage holding ratio at a temperature close to the maximum temperature of nematic phase as well as at room temperature, after being used for long time. The expression “increase the dielectric anisotropy” means that Δ∈ value increases positively when the composition has a positive Δ∈, and that the Δ∈ value increases negatively when the composition has a negative Δ∈.

A compound represented by formula (1) is often abbreviated to “compound (1).” At least one compound selected from the group consisting of compounds represented by formula (3) is often abbreviated to “compound (3).” “Compound (3)” means one compound, a mixture of two compounds or a mixture of three or more compounds represented by formula (3). This applies to compounds represented by other formulae. The expression “at least one ‘A’” means that the number of ‘A’ is arbitrary. The expression “at least one ‘A’ may be replaced by ‘B’” means that the position of ‘A’ is arbitrary when the number of ‘A’ is one, and the positions can also be selected without restriction when the number of ‘A’ is two or more. This rule also applies to the expression “at least one ‘A’ has been replaced by ‘B’.”

The symbol for the terminal group, R⁵, is used for a plurality of compounds in the chemical formulae of component compounds. In these compounds, two groups represented by arbitrary two R⁵ may be the same or different. In one case, for example, R⁵ of compound (5-1) is ethyl and R⁵ of compound (5-2) is ethyl. In another case, R⁵ of compound (5-1) is ethyl and R⁵ of compound (5-2) is propyl. The same rule applies to symbols such as another terminal group. In formula (5), two rings B are present when p is 2. In this compound, two groups represented by two rings B may be the same or different. The same rule applies to arbitrary two rings B when p is greater than 2. The same rule also applies to symbols such as Z¹ and ring L. The same rule also applies to the case of two -Sp²-P⁵ in compound (4-27), for instance.

The symbol such as A, B or C surrounded by a hexagonal shape corresponds to a 6-membered ring A, B or C. In compound (6), the hexagonal shape represents a 6-membered ring or a fused ring. An oblique line crossing the hexagonal shape means that arbitrary hydrogen on the ring may be substituted by a group such as -Sp¹-P¹. A subscript such as h means the number of the substituent (s). There is no replacement when the subscript is 0 (zero). A plurality of -Sp¹-P¹ are present on ring K when h is 2 or more. A plurality of groups represented by -Sp¹-P¹ may be the same or different.

2-Fluoro-1,4-phenylene means one of the two divalent groups described below. Fluorine may face left (L) or face right (R) in the chemical formula. The same rule also applies to other asymmetric divalent ring groups, such as tetrahydropyran-2,5-diyl. The same rule also applies to some divalent bonding groups such as carbonyloxy.

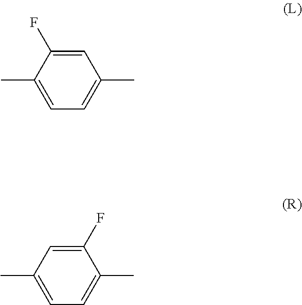

The invention includes the following items.

Item 1 is a liquid crystal composition having a negative dielectric anisotropy and comprising a compound represented by formula (1) as a first component, a compound represented by formula (2) as a second component, and at least one compound selected from the group consisting of compounds represented by formula (3) as a third component, wherein the proportion of the first component is in the range of 10 wt % to 25 wt % based on the weight of the liquid crystal composition:

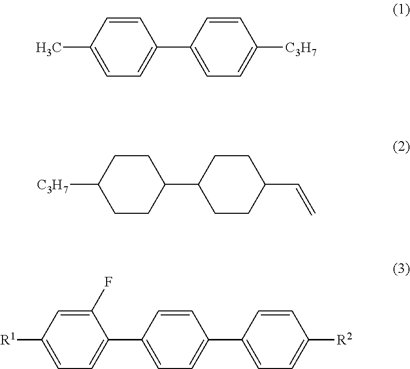

and in formula (3), R¹ and R² are independently alkyl having 1 to 12 carbons, alkoxy having 1 to 12 carbons or alkenyl having 2 to 12 carbons.

Item 2 is the liquid crystal composition of item 1 in which the proportion of the second component is in the range of 10 wt % to 60 wt % and the proportion of the third component is in the range of 5 wt % to 25 wt %, based on the weight of the liquid crystal composition.

Item 3 is the liquid crystal composition of item 1 or 2 which further comprises at least one compound selected from the group consisting of compounds represented by formula (4) as a fourth component:

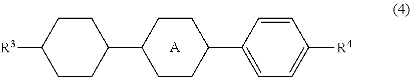

wherein in formula (4), R³ and R⁴ are independently alkyl having 1 to 12 carbons, alkoxy having 1 to 12 carbons or alkenyl having 2 to 12 carbons, and ring A is 1,4-cyclohexylene or 1,4-phenylene.

Item 4 is the liquid crystal composition of item 3 in which the proportion of the fourth component is in the range of 5 wt % to 25 wt % based on the weight of the liquid crystal composition.

Item 5 is the liquid crystal composition of anyone of items 1 to 4 which further comprises at least one compound selected from the group consisting of compounds represented by formula (5) as a fifth component:

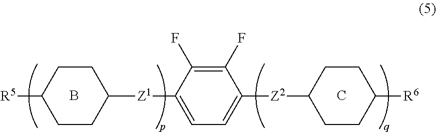

wherein in formula (5), R⁵ and R⁶ are independently alkyl having 1 to 12 carbons, alkoxy having 1 to 12 carbons or alkenyl having 2 to 12 carbons; ring B and ring C are independently 1,4-cyclohexylene, 1,4-cyclohexenylene, 1,4-phenylene, or 1,4-phenylene in which at least one hydrogen has been replaced by fluorine or chlorine; Z¹ and Z² are independently a single bond, ethylene, carbonyloxy or methyleneoxy; p is 1, 2 or 3; q is 0 or 1; and the sum of p and q is 3 or less.

Item 6 is the liquid crystal composition of item 5 in which the fifth component comprises at least one compound selected from the group consisting of compounds represented by formulae (5-1) to (5-11):

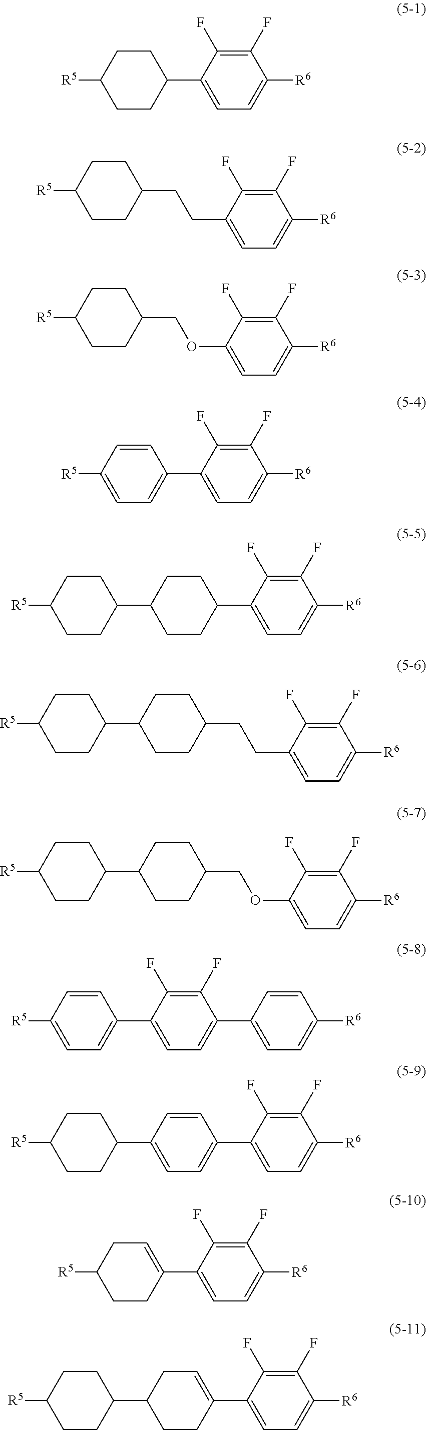

and in formulae (5-1) to (5-11), R⁵ and R⁶ are independently alkyl having 1 to 12 carbons, alkoxy having 1 to 12 carbons or alkenyl having 2 to 12 carbons.

Item 7 is the liquid crystal composition of item 5 or 6 in which the proportion of the fifth component is in the range of 15 wt % to 70 wt % based on the weight of the liquid crystal composition.

Item 8 is the liquid crystal composition of any one of items 1 to 7 which further comprises at least one polymerizable compound selected from the group consisting of compounds represented by formula (6) as an additive component:

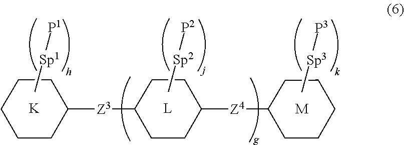

wherein in formula (6),

ring K and ring M are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in these rings at least one hydrogen may be replaced by fluorine, chlorine, alkyl having 1 to 12 carbons, alkoxy having 1 to 12 carbons, or alkyl having 1 to 12 carbons in which at least one hydrogen has been replaced by fluorine or chlorine;

ring L is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in these rings at least one hydrogen may be replaced by fluorine, chlorine, alkyl having 1 to 12 carbons, alkoxy having 1 to 12 carbons, or alkyl having 1 to 12 carbons in which at least one hydrogen has been replaced by fluorine or chlorine;

Z³ and Z⁴ are independently a single bond or alkylene having 1 to 10 carbons, and in this alkylene at least one —CH₂— may be replaced by —O—, —CO—, —COO— or —OCO—, and at least one —CH₂—CH₂— may be replaced by —CH═CH—, —C(CH₃)═CH—, —CH═C(CH₃)— or —C(CH₃)═C(CH₃)—, and in these groups at least one hydrogen may be replaced by fluorine or chlorine;

P¹, P² and P³ are independently a polymerizable group;

Sp¹, Sp² and Sp³ are independently a single bond or alkylene having 1 to 10 carbons, and in this alkylene at least one —CH₂— may be replaced by —O—, —COO—, —OCO— or —OCOO—, and at least one —CH₂—CH₂— may be replaced by —CH═CH— or —C≡C—, and in these groups at least one hydrogen may be replaced by fluorine or chlorine;

g is 0, 1 or 2;

h, j and k are independently 0, 1, 2, 3 or 4; and

the sum of h, j and k is 1 or more.

Item 9 is the liquid crystal composition of item 8 in which in formula (6), P¹, P² and P³ are independently a polymerizable group selected from the group consisting of groups represented by formulae (P-1) to (P-5):

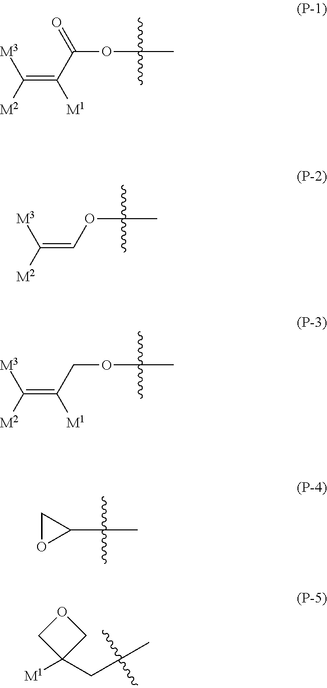

and in formulae (P-1) to (P-5), M¹, M² and M³ are independently hydrogen, fluorine, alkyl having 1 to 5 carbons, or alkyl having 1 to 5 carbons in which at least one hydrogen has been replaced by fluorine or chlorine.

Item 10 is the liquid crystal composition of item 8 or 9 in which the additive component comprises at least one polymerizable compound selected from the group consisting of compounds represented by formulae (6-1) to (6-27):

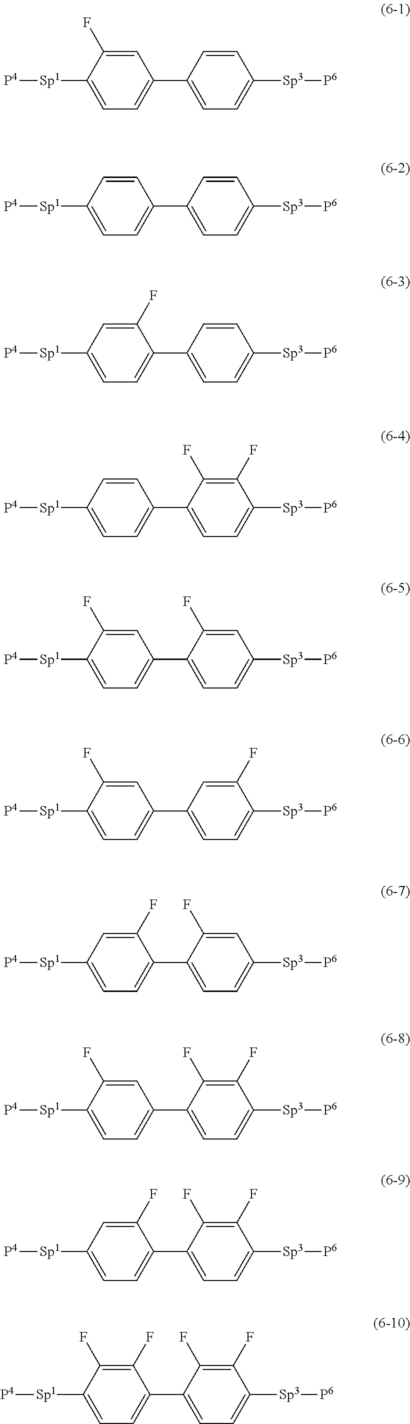

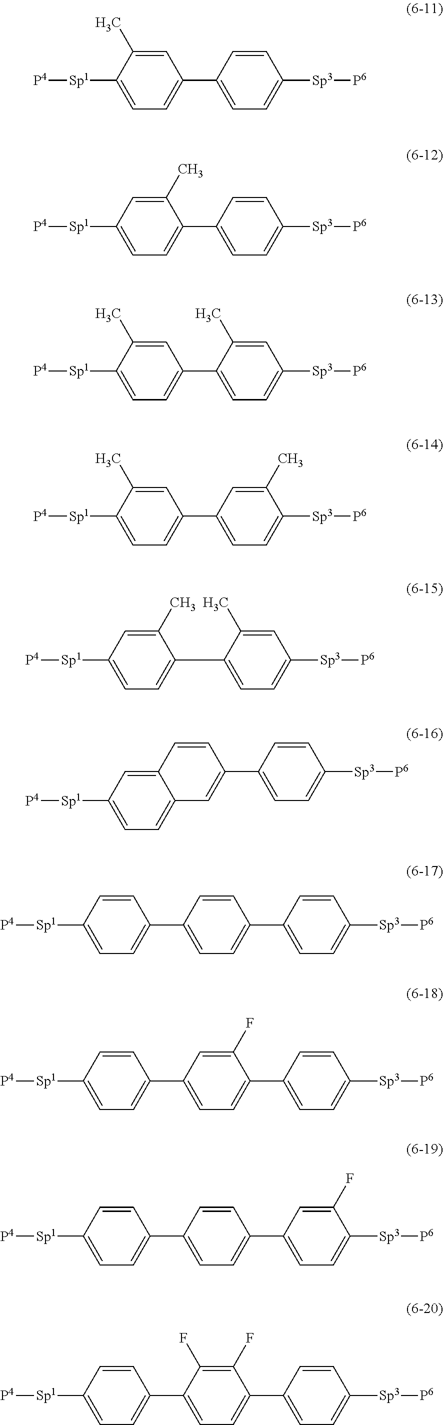

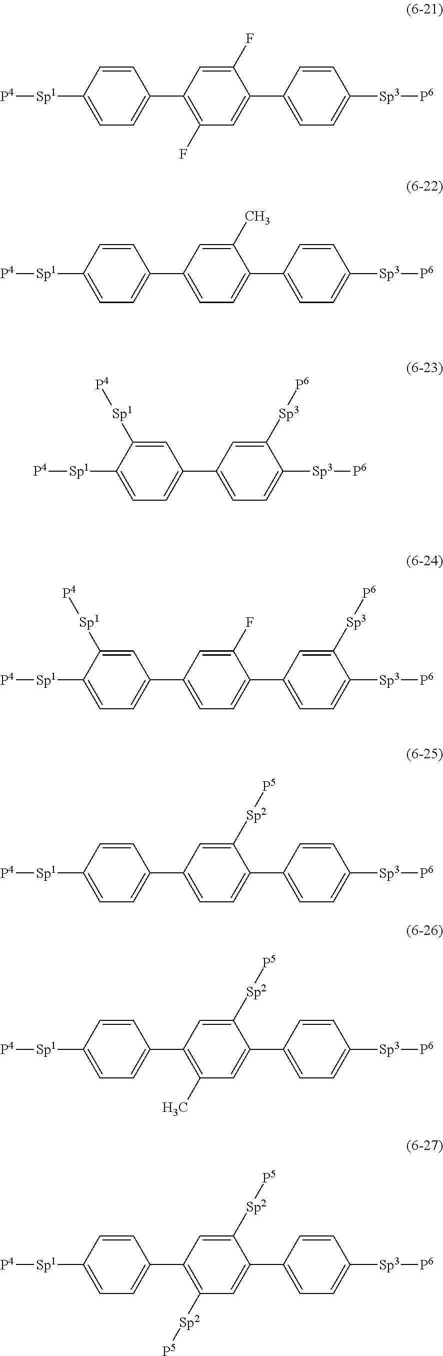

in formulae (6-1) to (6-27), P⁴, P⁵ and P⁶ are independently a polymerizable group selected from the group consisting of groups represented by formulae (P-1) to (P-3);

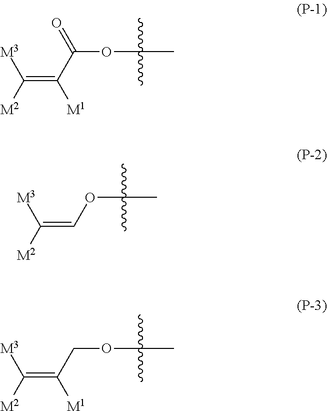

in formulae (P-1) to (P-3), M¹, M² and M³ are independently hydrogen, fluorine, alkyl having 1 to 5 carbons, or alkyl having 1 to 5 carbons in which at least one hydrogen has been replaced by fluorine or chlorine; and
in formulae (6-1) to (6-27), Sp¹, Sp² and Sp³ are independently a single bond or alkylene having 1 to 10 carbons, and in this alkylene at least one —CH₂— may be replaced by —O—, —COO—, —OCO— or —OCOO— and at least one —CH₂—CH₂— may be replaced by —CH═CH— or —C≡C—, and in these groups at least one hydrogen may be replaced by fluorine or chlorine.

Item 11 is the liquid crystal composition of any one of items 8 to 10 in which the proportion of the additive component is in the range of 0.03 wt % to 10 wt % based on the weight of the liquid crystal composition.

Item 12 is an LCD device comprising the liquid crystal composition of any one of items 1 to 11.

Item 13 is the liquid crystal display device of item 12 of which the operating mode is an IPS mode, a VA mode, an FFS mode or an FPA mode, and the driving mode is an active matrix mode.

Item 14 is an LCD device of a polymer sustained alignment (PSA) type comprising the liquid crystal composition of any of items 1 to 11 in which the polymerizable compound has been polymerized.

Item 15 is use of the liquid crystal composition of any one of items 1 to 11 for an LCD device.

Item 16 is use of the liquid crystal composition of any one of items 1 to 11 for an LCD device of a PSA type.

The invention further includes the following items: a) the composition described above which further comprises at least one of additives such as an optically active compound, an antioxidant, an UV light absorbent, a coloring matter, an antifoaming agent, a polymerizable compound, a polymerization initiator and a polymerization inhibitor; b) an AM device comprising the above composition; c) the above composition which further comprises a polymerizable compound, and an AM device of a PSA mode comprising this composition; d) an AM device of a PSA mode comprising the above composition in which a polymerizable compound has been polymerized; e) a device comprising the above composition and having a mode of PC, TN, STN, ECB, OCE, IPS, VA, FFS or FPA; f) a transmission-type device comprising the above composition; g) use of the above composition as a composition having a nematic phase; and h) use of the composition prepared by adding an optically active compound to the above composition, as an optically active composition.

The composition of the invention will be explained in the following order. First, the constitution of component compounds in the composition is explained. Second, the main characteristics of the component compounds and the main effects of these compounds on the composition are explained. Third, the combination of the components in the composition, desirable proportions of the components and the bases thereof are explained. Fourth, desirable embodiments of the component compounds are explained. Fifth, desirable component compounds are shown. Sixth, additives that may be added to the composition are explained. Seventh, methods for synthesizing the component compounds are explained. Last, the use of the composition is explained.

First, the constitution of the component compounds in the composition is explained. The compositions of the invention are classified into composition A and composition B. Composition A may further comprise any other liquid crystal compound, an additive and so forth, in addition to liquid crystal compounds selected from compounds (1), (2), (3), (4) and (5). “Any other liquid crystal compound” is a liquid crystal compound different from compounds (1), (2), (3), (4) and (5). Such a compound is mixed with the composition for further adjusting the characteristics. The additive includes an optically active compound, an antioxidant, an UV light absorbent, a coloring matter, an antifoaming agent, a polymerizable compound, a polymerization initiator and a polymerization inhibitor.

Composition B consists essentially of liquid crystal compounds selected from compounds (1), (2), (3), (4) and (5). The term “essentially” means that the composition may comprise an additive, but does not comprise any other liquid crystal compound. Composition B has a smaller number of components than composition A. Composition B is preferred to composition A in view of cost reduction. Composition A is preferred to composition B in view of the fact that characteristics can be further adjusted by mixing with any other liquid crystal compound.

Second, the main characteristics of the component compounds and the main effects of these compounds on the characteristics of the composition are explained. Table 2 summarizes the main characteristics of the component compounds based on the effects of the invention. In Table 2, the symbol L stands for “large” or “high”, M stands for “medium”, and S stands for “small” or “low.” The symbols are for a classification based on a qualitative comparison of the component compounds, and 0 (zero) means a value being nearly zero.

TABLE 2
Characteristics of Compounds

| | Compound | | | | |
|---|---|---|---|---|---|
| | (1) | (2) | (3) | (4) | (5) |
| Maximum Temperature | S | S | M | L | S-L |
| Viscosity | S | S | M | M | M-L |
| Optical Anisotropy | M | S | L | M | M-L |
| Dielectric Anisotropy | 0 | 0 | 0 | 0 | M-L¹⁾ |
| Specific Resistance | L | L | L | L | L |

¹⁾The value of the dielectric anisotropy is negative, and the symbol expresses the magnitude of the absolute value.

The main effects of the component compounds on the characteristics of the composition upon mixing with the composition are as follows. Compound (1) increases the optical anisotropy, and decreases the viscosity. Compound (2) decreases the viscosity. Compound (3) increases the optical anisotropy. Compound (4) increases the maximum temperature. Compound (5) increases the dielectric anisotropy, and decreases the minimum temperature. Compound (6) gives a polymer by polymerization, wherein the polymer decreases the response time of the device and reduces image burn-in.

Third, a combination of the components in the composition, desirable proportions of the components and the bases thereof are explained. The combination of the components in the composition is the 1^{st}, 2^{nd} and 3^{rd} components, the 1^{st}, 2^{nd}, 3^{rd} and 4^{th} components, the 1^{st}, 2^{nd}, 3^{rd} and 5^{th} components, the 1^{st}, 2^{nd}, 3^{rd} and additive components, the 1^{st}, 2^{nd}, 3^{rd}, 4^{th} and 5^{th} components, the 1^{st}, 2^{nd}, 3^{rd}, 4^{th} and additive components, the 1^{st}, 2^{nd}, 3^{rd}, 5^{th} and additive components, or the 1^{st}, 2^{nd}, 3^{rd}, 4^{th}, 5^{th} and additive components. A more desirable combination is the 1^{st}, 2^{nd}, 3^{rd} and 5^{th} components, the 1^{st}, 2^{nd}, 3^{rd}, 5^{th} and additive components, the 1^{st}, 2^{nd}, 3^{rd}, 4^{th} and 5^{th} components, or the 1^{st} to 5^{th} and additive components.

A desirable proportion of the first component is about 10 wt % or more for decreasing the viscosity, and about 25 wt % or less for decreasing the minimum temperature, based on the weight of the liquid crystal composition. Amore desirable proportion is in the range of about 10 wt % to about 20 wt %.

A desirable proportion of the second component is about 10 wt % for decreasing the viscosity, and about 60 wt % or less for increasing the dielectric anisotropy, based on the weight of the liquid crystal composition. Amore desirable proportion is in the range of about 20 wt % to about 55 wt %. A particularly desirable proportion is in the range of about 25 wt % to about 50 wt %.

A desirable proportion of the third component is about 5 wt % or more for increasing the maximum temperature or for increasing the optical anisotropy, and about 25 wt % or less for decreasing the minimum temperature, based on the weight of the liquid crystal composition. Amore desirable proportion is in the range of about 5 wt % to about 20 wt %. A particularly desirable proportion is in the range of about 5 wt % to about 15 wt %.

A desirable proportion of the fourth component is about 5 wt % or more for increasing the maximum temperature, and about 25 wt % or less for increasing Δ∈, based on the weight of the liquid crystal composition. A more desirable proportion is in the range of about 5 wt % to about 20 wt %. A particularly desirable proportion is in the range of about 5 wt % to about 15 wt %.

A desirable proportion of the fifth component is about 15 wt % or more for increasing Δ∈, and about 70 wt % or less for decreasing the minimum temperature, based on the weight of the liquid crystal composition. Amore desirable proportion is in the range of about 20 wt % to about 65 wt %. A particularly desirable proportion is in the range of about 25 wt % to about 60 wt %.

Compound (6) is added to the composition for adapting to a device of a PSA type. A desirable proportion of the additive is about 0.03 wt % or more for orienting liquid crystal molecules, and about 10 wt % or less for preventing display defects of a device, based on the weight of the liquid crystal composition. A more desirable proportion is in the range of about 0.1 wt % to about 2 wt %. A particularly desirable proportion is in the range of about 0.2 wt % to about 1.0 wt %.

Fourth, a desirable embodiment of the component compounds are explained. In formulae (3), (4) and (5), R¹, R², R³, R⁴, R⁵ and R⁶ are independently alkyl having 1 to 12 carbons, alkoxy having 1 to 12 carbons or alkenyl having 2 to 12 carbons. Desirable R¹, R², R³ or R⁴ is alkenyl having 2 to 12 carbons for decreasing the viscosity, or is alkyl having 1 to 12 carbons for increasing the stability. Desirable R⁵ or R⁶ is alkyl having 1 to 12 carbons for increasing the stability, or is alkoxy having 1 to 12 carbons for increasing the dielectric anisotropy. The alkyl has a straight chain or a branched chain, and does not include cycloalkyl. Straight alkyl is preferred to branched alkyl. The same rule also applies to a terminal group such as alkoxy and alkenyl.

Desirable alkyl is methyl, ethyl, propyl, butyl, pentyl, hexyl, heptyl or octyl. More desirable alkyl is ethyl, propyl, butyl, pentyl or heptyl for decreasing the viscosity.

Desirable alkoxy is methoxy, ethoxy, propoxy, butoxy, pentyloxy, hexyloxy or heptyloxy. More desirable alkoxy is methoxy or ethoxy for decreasing the viscosity.

Desirable alkenyl is vinyl, 1-propenyl, 2-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl or 5-hexenyl. More desirable alkenyl is vinyl, 1-propenyl, 3-butenyl or 3-pentenyl for decreasing the viscosity. A desirable configuration of —CH═CH— in the alkenyl depends on the position of the double bond. Trans is preferred for alkenyl groups such as 1-propenyl, 1-butenyl, 1-pentenyl, 1-hexenyl, 3-pentenyl and 3-hexenyl for decreasing the viscosity. Cis is preferred for alkenyl groups such as 2-butenyl, 2-pentenyl and 2-hexenyl.

Ring A is 1,4-cyclohexylene or 1,4-phenylene. Ring B and ring C are independently 1,4-cyclohexylene, 1,4-cyclohexenylene, 1,4-phenylene, or 1,4-phenylene in which at least one hydrogen has been replaced by fluorine or chlorine. Desirable ring B or ring C is 1,4-cyclohexylene for decreasing the viscosity, and 1,4-phenylene for increasing the optical anisotropy. With regard to the configuration of 1,4-cyclohexylene, trans is preferred to cis for increasing the maximum temperature.

Z¹ and Z² are independently a single bond, ethylene, carbonyloxy or methyleneoxy. Desirable Z¹ or Z² is a single bond for decreasing the viscosity, or is ethylene for decreasing the minimum temperature, or is methyleneoxy for increasing Δ∈.

p is 1, 2 or 3, q is 0 or 1, and the sum of p and q is 3 or less. Desirable p is 1 for decreasing the viscosity, or is 2 or 3 for increasing the maximum temperature. Desirable q is 0 for decreasing the viscosity, or is 1 for decreasing the minimum temperature.

In formula (6) and formulae (6-1) to (6-27), Sp′, Sp² and Sp³ are independently a single bond or alkylene having 1 to 10 carbons, and in this alkylene at least one —CH₂— may be replaced by —O—, —COO—, —OCO— or —OCOO—, and at least one —CH₂—CH₂— may be replaced by —CH═CH— or —C≡C—, and in these groups at least one hydrogen may be replaced by fluorine or chlorine. Desirable Sp¹, Sp² or Sp³ is a single bond.

In formula (6), P¹, P² and P³ are independently a polymerizable group. Desirable P¹. P² or P³ is a polymerizable group selected from the group consisting of groups represented by formulae (P-1) to (P-5). More desirable P¹, P² or P³ is a group represented by formula (P-1), (P-2) or (P-3). Particularly desirable P¹, P² or P³ is a group represented by formula (P-1) or (P-2). The most desirable P¹, P² or P³ is a group represented by formula (P-1). A desirable group represented by formula (P-1) is —OCO—CH═CH₂ or —OCO—C(CH₃)═CH₂. The wavy line in any of formulae (P-1) to (P-5) indicates the binding site.

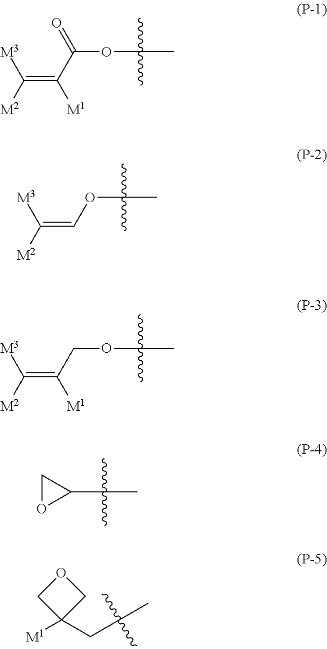

In formulae (P-1) to (P-5), M¹, M² and M³ are independently hydrogen, fluorine, alkyl having 1 to 5 carbons, or alkyl having 1 to 5 carbons in which at least one hydrogen has been replaced by fluorine or chlorine. Desirable M¹, M² or M³ is hydrogen or methyl for increasing the reactivity. More desirable M¹ is hydrogen or methyl, and more desirable M² or M³ is hydrogen.

Sp¹, Sp² and Sp³ are independently a single bond or alkylene having 1 to 10 carbons, and in the alkylene at least one —CH₂— may be replaced by —O—, —OCO—, —OCO— or —OCOO—, and at least one —CH₂—CH₂— may be replaced by —CH═CH— or —C≡C—, and in these groups at least one hydrogen may be replaced by fluorine or chlorine. Desirable Sp¹, Sp² or Sp³ is a single bond, —CH₂CH₂—, —CH₂O—, —OCH₂—, —COO—, —OCO—, —CO—CH═CH— or —CH═CH—CO—. More desirable Sp¹, Sp² or Sp³ is a single bond.

Ring K and ring M are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in these rings at least one hydrogen may be replaced by fluorine, chlorine, alkyl having 1 to 12 carbons, alkoxy having 1 to 12 carbons, or alkyl having 1 to 12 carbons in which at least one hydrogen has been replaced by fluorine or chlorine. Desirable ring K or ring M is phenyl. Ring L is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in these rings at least one hydrogen may be replaced by fluorine, chlorine, alkyl having 1 to 12 carbons, alkoxy having 1 to 12 carbons, or alkyl having 1 to 12 carbons in which at least one hydrogen has been replaced by fluorine or chlorine. Desirable ring L is 1,4-phenylene or 2-fluoro-1,4-phenylene.

Z³ and Z⁴ are independently a single bond or alkylene having 1 to 10 carbons, and in this alkylene at least one —CH₂— may be replaced by —O—, —CO—, —COO— or —OCO—, and at least one —CH₂—CH₂— may be replaced by —CH═CH—, —C(CH₃)═CH—, —CH═C(CH₃)— or —C(CH₃)═C(CH₃)—, and in these groups at least one hydrogen may be replaced by fluorine or chlorine. Desirable Z³ or Z⁴ is a single bond, —CH₂CH₂—, —CH₂O—, —OCH₂—, —COO— or —OCO—. More desirable Z³ or Z⁴ is a single bond.

g is 0, 1 or 2. Desirable g is 0 or 1. h, j and k are independently 0, 1, 2, 3 or 4, and the sum of h, j and k is 1 or more. Desirable h, j or k is 1 or 2.

Fifth, desirable component compounds are shown. Desirable compounds (5) are compounds (5-1) to (5-11) of item 6. It is desirable that at least one compound in the fifth component should be compound (5-1), (5-3), (5-4), (5-5), (5-7) or (5-9) among these compounds. It is desirable that at least two compounds in the fifth component should be a combination of compounds (5-1) and (5-5), compounds (5-3) and (5-5), compounds (5-3) and (5-9), compounds (5-4) and (5-5) or compounds (5-4) and (5-7).

Desirable compounds (6) are compounds (6-1) to (6-27) according to item 10. It is desirable that at least one compound in the additive component should be compound (6-1), (6-2), (6-24), (6-25), (6-26) or (6-27) among these compounds. It is desirable that at least two compounds in the additive component should be a combination of compounds (6-1) and (6-2), compounds (6-1) and (6-18), compounds (6-2) and (6-24), compounds (6-2) and (6-25), compounds (6-2) and (6-26), compounds (6-25) and (6-26) or compounds (6-18) and (6-24).

Sixth, additives that may be added to the composition are explained. Such additives include an optically active compound, an antioxidant, an UV light absorbent, a coloring matter, an antifoaming agent, a polymerizable compound, a polymerization initiator and a polymerization inhibitor. The optically active compound is added to the composition for inducing a helical structure of liquid crystal molecules and giving a twist angle. Examples of such compounds are compounds (7-1) to (7-5). A desirable proportion of the optically active compound is about 5 wt % or less based on the weight of the liquid crystal composition. A more desirable proportion is in the range of about 0.01 wt % to about 2 wt %.

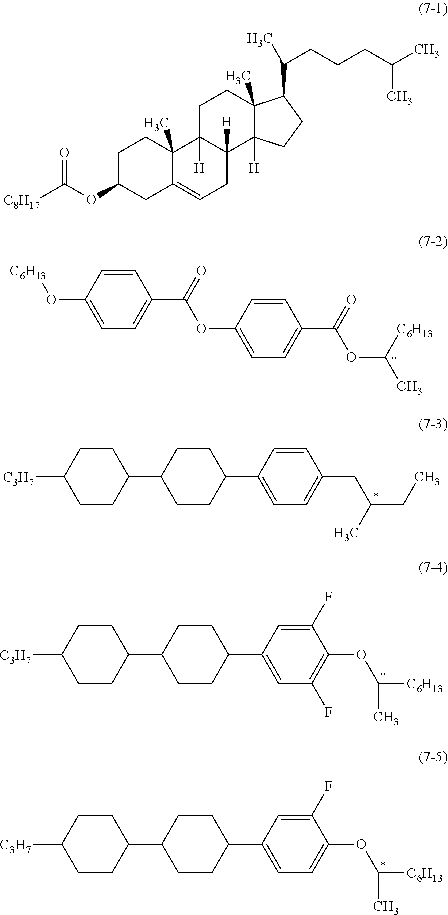

The antioxidant is added to the composition for preventing a decrease in specific resistance that is caused by heating under air, or maintaining a large voltage holding ratio at a temperature close to the maximum temperature as well as at room temperature, after the device is used for long time. A desirable example of the antioxidant is compound (8) where n is an integer of 1 to 9.

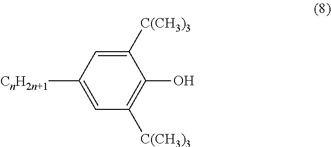

For compound (8), desirable n is 1, 3, 5, 7 or 9, and more desirable n is 7. Compound (8) of n=7 is effective in maintaining a large voltage holding ratio at a temperature close to the maximum temperature as well as at room temperature after the device is used for long time, as having a low volatility. A desirable proportion of the antioxidant is about 50 ppm or more for achieving its effect and is about 600 ppm or less for avoiding a decrease in the maximum temperature or an increase in the minimum temperature. A more desirable proportion ranges from about 100 ppm to about 300 ppm.

Desirable examples of the UV light absorbent include benzophenone derivatives, benzoate derivatives and triazole derivatives. A light stabilizer such as an amine having steric hindrance is also desirable. A desirable proportion of the UV light absorbent or the light stabilizer is about 50 ppm or more for achieving its effect, and is about 10,000 ppm or less for avoiding a decrease in the maximum temperature or avoiding an increase in the minimum temperature. A more desirable proportion is in the range of about 100 ppm to about 10,000 ppm.

A dichroic dye such as an azo dye or an anthraquinone dye is added to the composition for adapting to a device having a guest host (GH) mode. A desirable proportion of the coloring matter is in the range of about 0.01 wt % to about 10 wt % based on the weight of the liquid crystal composition. The antifoaming agent such as dimethyl silicone oil or methyl phenyl silicone oil is added to the composition for preventing foam formation. A desirable proportion of the antifoaming agent is about 1 ppm or more for achieving its effect, and is about 1,000 ppm or less for avoiding a poor display. A more desirable proportion is in the range of about 1 ppm to about 500 ppm.

The polymerizable compound is used for adapting to a device of a PSA type. Compound (6) is suitable for this purpose. A polymerizable compound different from compound (6) may be added to the composition, together with compound (6). Instead of compound (6), a polymerizable compound different from compound (6) may be added to the composition. Desired examples of such polymerizable compound include compounds such as acrylates, methacrylates, vinyl compounds, vinyloxy compounds, propenyl ethers, epoxy compounds (oxiranes, oxetanes) and vinyl ketones. More desirable examples are acrylate derivatives or methacrylate derivatives. A desirable proportion of compound (6) is about 10 wt % or more based on the total weight of the polymerizable compound. A more desirable proportion is about 50 wt % or more. A particularly desirable proportion is about 80 wt % or more. The most desirable proportion is 100 wt %.

A polymerizable compound such as compound (6) is polymerized on irradiation with UV light. It may be polymerized in the presence of an initiator such as a photo-polymerization initiator. Suitable conditions for polymerization, and a suitable type and amount of the initiator are known to a person or ordinary skill in the art, and are described in the literature. For example, Irgacure 651™ (from BASF), Irgacure 184™ (from BASF) or Darocure 1173™ (from BASF), each of which is a photo-initiator, is suitable for radical polymerization. A desired proportion of the photo-polymerization initiator is in the range of about 0.1 wt % to about 5 wt % based on the weight of the polymerizable compound. A more desirable proportion is in the range of about 1 wt % to about 3 wt %.

The polymerization inhibitor may be added to prevent polymerization when a polymerizable compound such as compound (6) is kept in storage. The polymerizable compound is usually added to the composition without removing the polymerization inhibitor. Examples of the polymerization inhibitor include hydroquinone derivatives such as hydroquinone and methylhydroquinone, 4-tert-butylcatechol, 4-methoxyphenol and phenothiazine.

Seventh, methods for synthesizing the component compounds are explained. These compounds can be synthesized by known methods such as those exemplified below. Compound (1) may be prepared by the method described in JP S52-53783 A (1977). Compound (2) may be prepared by the method described in JP S59-176221 A (1984). Compound (3) may be prepared by the method described in JP 2006-503130 A. Compound (4) may be prepared by the method described in JP S57-165328 A (1982). Compound (5-1) may be prepared by the method described in JP H02-503441 A (1990). Compound (6-18) may be prepared by the method described in JP H07-101900 A (1995). An antioxidant may be commercially available. A compound of formula (8) of n=1 is available from Sigma-Aldrich Corporation. Compound (8) of n=7, for instance, may be synthesized with the method described in U.S. Pat. No. 3,660,505.

Compounds whose synthetic methods are not described above can be prepared with the methods described in books such as “Organic Syntheses” (John Wiley & Sons, Inc.), “Organic Reactions” (John Wiley & Sons, Inc.), “Comprehensive Organic Synthesis” (Pergamon Press), and “New Experimental Chemistry Course” (Maruzen Co., Ltd., Japan). The composition may be prepared with known methods using the compounds thus obtained. For example, the component compounds are mixed and dissolved in each other by heating.

Last, the use of the composition is explained. Most of the compositions have a minimum temperature of about −10° C. or lower, a maximum temperature of about 70° C. or higher, and an optical anisotropy in the range of about 0.07 to about 0.20. A composition having Δn in the range of about 0.08 to about 0.25 may be prepared by adjusting the ratio of the component compounds or by mixing with any other liquid crystal compound. Further, a composition having Δn in the range of about 0.10 to about 0.30 may be prepared by this method. A device comprising this composition has a large voltage holding ratio. This composition is suitable for an AM device. This composition is suitable particularly for an AM device having a transmission type. This composition can be used as a composition having a nematic phase and as an optically active composition by adding an optically active compound.

The composition can be used for an AM device, and can also be used for a PM device. The composition can also be used for an AM device or a PM device having a mode such as PC, TN, STN, ECB, OCB, IPS, FFS, VA and FPA. It is particularly desirable to use the composition for an AM device having a mode of TN, OCB, IPS or FFS. In an AM device of an IPS or FFS mode, the orientation of liquid crystal molecules may be parallel or perpendicular to a glass substrate, when no voltage is applied. These devices may be of a reflection type, a transmission type or a semi-transmission type. It is desirable to use the composition for a device of a transmission type. The composition can be used for an amorphous silicon TFT device or a poly-Si TFT device. The composition is also usable for an NCAP (nematic curvilinear aligned phase) device prepared by micro-capsulating the composition, and for a PD (polymer dispersed) device in which a 3D network-polymer is formed in the composition.

### EXAMPLES

The invention will be explained in more details by way of examples, but is not limited thereto. For example, the invention also includes a mixture of the composition in Example 1 and the composition in Example 2, and even a mixture prepared by mixing at least two of the compositions in Examples. Compounds prepared herein were identified by methods such as NMR analysis. The characteristics of the compounds, compositions and devices were measured by the methods described below.

NMR Analysis:

A model DRX-500 apparatus made by Bruker BioSpin Corporation was used for measurement. In the measurement of ¹H-NMR, a sample was dissolved in a deuterated solvent such as CDCl₃, and the measurement was carried out under the conditions of room temperature, 500 MHz and an accumulation of 16 scans. Tetramethylsilane was used as an internal standard. In the measurement of ¹⁹F-NMR, CFCl₃ was used as an internal standard, and 24 scans were accumulated. In the explanation of the nuclear magnetic resonance spectra, the symbols s, d, t, q, quin, sex, m and br stand for a singlet, a doublet, a triplet, a quartet, a quintet, a sextet, a multiplet and a broad peak, respectively.

Gas Chromatographic Analysis:

A gas chromatograph Model GC-14B made by Shimadzu Corporation was used for the measurement. The carrier gas was helium (2 mL/min). The sample injector and the detector (FID) were set to 280° C. and 300° C., respectively. A capillary column DB-1 (length: 30 m, bore: 0.32 mm, film thickness: 0.25 μm; dimethylpolysiloxane as the stationary phase, non-polar) made by Agilent Technologies, Inc. was used to separate the component compounds. After being kept at 200° C. for 2 min, the column was further heated to 280° C. at a rate of 5° C./mm. A sample was dissolved in acetone (0.1 wt %), and 1 μL of the solution was injected into the sample injector. The recorder used was Model C-R5A Chromatopac Integrator made by Shimadzu Corporation or its equivalent. The resulting gas chromatogram showed the retention time of peaks and the peak areas corresponding to the component compounds.

A solvent such as chloroform or hexane, etc. may also be used to dilute the sample. The following capillary columns may also be used to separate the component compounds: HP-1 made by Agilent Technologies Inc. (length: 30 m, bore: 0.32 mm, film thickness: 0.25 μm), Rtx-1 made by Restek Corporation (length: 30 m, bore: 0.32 mm, film thickness: 0.25 μm), and BP-1 made by SGE International Pty. Ltd. (length: 30 m, bore: 0.32 mm, film thickness: 0.25 μm). A capillary column CBP1-M50-025 (length: 50 m, bore: 0.25 mm, film thickness: 0.25 μm) made by Shimadzu Corporation may also be used for avoiding an overlap of peaks of the compounds.

The ratio of the liquid crystal compounds comprised in the composition may be calculated with the following method. A mixture of the liquid crystal compounds were detected using a gas chromatograph (FID). The ratio of peak areas in the gas chromatogram corresponds to the ratio (weight ratio) of the liquid crystal compounds. When the capillary columns described above are used, the correction coefficient of respective liquid crystal compounds may be regarded as 1 (one). Accordingly, the proportions (in weight percentage) of the liquid crystal compounds can be calculated from the ratio of the peak areas.

Samples for Measurement:

A composition itself was used as a sample when the characteristics of the composition or the device were measured. When the characteristics of a compound were measured, a sample for measurement was prepared by mixing this compound (15 wt %) with a mother liquid crystal (85 wt %). The characteristic values of the compound were calculated from the values obtained from the measurements by an extrapolation method: (Extrapolated value)=(Measured value of sample)−0.85×(Measured value of mother liquid crystal)/0.15. When a smectic phase (or crystals) deposited at 25° C. at this ratio, the ratio of the compound to the mother liquid crystal was changed in the order of (10 wt %:90 wt %), (5 wt:95 wt %) and (1 wt %:99 wt %). The values of the maximum temperature, optical anisotropy, viscosity and dielectric anisotropy regarding the compound were obtained by means of this extrapolation method.

The mother liquid crystals described below were used. The proportions of the component compounds are expressed in weight percentage.

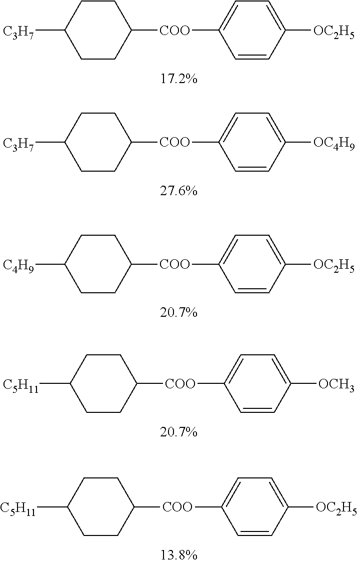

Measurement Methods:

Characteristics of compounds were measured with the methods below. Most of them are as described in the standard “JEITA-ED-2521B” deliberated and established by Japan Electronics and Information Technology Industries Association (JEITA), or as modified thereon. No thin film transistors (TFT) were attached to the TN device used for the measurement.

1) Maximum Temperature of Nematic Phase (NI; ° C.):

A sample was placed on a hot plate in a melting point apparatus equipped with a polarizing microscope and was heated at the rate of 1° C./rain. The temperature at which a part of the sample began to change from a nematic phase to an isotropic liquid was measured. The higher limit of the temperature range of the nematic phase may be abbreviated to “the maximum temperature.”

2) Minimum Temperature of Nematic Phase (Tc; ° C.):

A sample having a nematic phase was placed in glass vials and then kept in freezers at temperatures of 0° C., −10° C., −20° C., −30° C. and −40° C. for 10 days, and then the liquid crystal phases were observed. For example, when the sample maintained the nematic phase at −20° C. and changed to crystals or a smectic phase at −30° C., To was expressed as “<−20° C.” The lower limit of the temperature range of the nematic phase may be abbreviated to “the minimum temperature.”

3) Viscosity (bulk viscosity; η; measured at 20° C.; mPa·s):

An E-type viscometer made by Tokyo Keiki Inc. was used for the measurement.

4) Viscosity (rotational viscosity; γ1; measured at 25° C.; mPa·s):

The measurement was carried out with the method described in M. Imai, et al., Molecular Crystals and Liquid Crystals, Vol. 259, p. 37 (1995). A sample was poured into a VA device in which the distance between the two glass substrates (cell gap) was 20 μm. A voltage in the range of 39 V to 50 V was applied stepwise with an increment of 1 volt to this device. After a period of 0.2 sec with no voltage, a voltage was applied repeatedly under the conditions of only one rectangular wave (rectangular pulse; 0.2 sec) and no voltage (2 sec). The peak current and the peak time of the transient current generated by the applied voltage were measured. The value of rotational viscosity was obtained from these measured values and Equation (8) in page 40 of the paper of M. Imai, et al. The value of the dielectric anisotropy necessary for the present calculation was measured with the method described in item 6).

5) Optical Anisotropy (Refractive Index Anisotropy; Δn; Measured at 25° C.):

The measurement was carried out using an Abbe refractometer with a polarizing plate attached to the ocular, using light at a wavelength of 589 nm. The surface of the main prism was rubbed in one direction, and then a sample was placed on the main prism. The refractive index n_{∥} was measured when the direction of the polarized light was parallel to that of rubbing. The refractive index n_{⊥} was measured when the direction of polarized light was perpendicular to that of rubbing. The value of the optical anisotropy (Δn) was calculated with the equation “Δn=n_{∥}−n_{⊥}.”

6) Dielectric Anisotropy (Δ∈; Measured at 25° C.):

The value of Δ∈ was calculated with the equation “Δ∈=∈_{∥}−∈_{⊥}.” The dielectric constants ∈_{∥} and ∈_{⊥} were measured as follows.

1) Measurement of dielectric constant ∈_{∥}: A solution of 0.16 mL of octadecyltriethoxysilane in 20 mL of ethanol was applied to fully cleaned glass substrates. The glass substrates were rotated with a spinner, and then heated at 150° C. for one hour. A sample was poured in a VA device in which the distance between the two glass substrates (cell gap) was 4 μm, and then this device was sealed with a UV-curable adhesive. Sine waves (0.5 V, 1 kHz) were applied to this device, and the dielectric constant ∈_{∥} in the major axis direction of liquid crystal molecules was measured after 2 sec.
2) Measurement of dielectric constant ∈_{⊥}: A polyimide solution was applied to fully cleaned glass substrates. The glass substrates were calcined, and then the resulting alignment film was subjected to rubbing. A sample was poured in a TN device in which the distance between the two glass substrates (cell gap) was 9 μm and the twist angle was 80°. Sine waves (0.5 V, 1 kHz) were applied to this device, and the dielectric constant ∈_{⊥} in the minor axis direction of liquid crystal molecules was measured after 2 sec.

7) Threshold Voltage (Vth; Measured at 25° C.; V):

The measurement was carried out with an LCD evaluation system Model LCD-5100 made by Otsuka Electronics Co., Ltd. The light source was a halogen lamp. A sample was poured into a VA device having a normally black mode, in which the distance between the two glass substrates (cell gap) was 4 μm and the rubbing direction was antiparallel, and then this device was sealed with a UV-curable adhesive. The voltage to be applied to this device (60 Hz, rectangular waves) was stepwise increased in 0.02 V increments from 0 V up to 20 V. During the increase, the device was vertically irradiated with light, and the amount of light passing through the device was measured. A voltage-transmittance curve was plotted, in which the maximum amount of light corresponded to 100% transmittance and the minimum amount of light corresponded to 0%, transmittance. The threshold voltage was the voltage at 10% transmittance.

8) Voltage Holding Ratio (VHR-1; measured at 25° C.; %):

A TN device used for the measurement had a polyimide alignment film, and the distance between the two glass substrates (cell gap) was 5 μm. A sample was poured in the device, and then this device was sealed with a UV-curable adhesive. A pulse voltage (60 μs at 5 V) was applied to this device to charge the device. The decaying voltage was measured for 16.7 milliseconds with a high-speed voltmeter, and area A between the voltage curve and the horizontal axis in a unit cycle was obtained. The voltage holding ratio was expressed as a percentage of area A to area B that was the area without decaying.

9) Voltage Holding Ratio (VHR-2; Measured at 80° C.; %):

The voltage holding ratio was measured by the method described above, except that it was measured at 80° C. instead of 25° C. The resulting values were represented by the symbol VHR-2.

10) Voltage Holding Ratio (VHR-3; Measured at 25° C.; %):

The stability to UV light was evaluated by measuring a voltage holding ratio after UV-irradiation. A TN device used for measurement had a polyimide alignment film and a cell gap of 5 μm. A sample was poured in this device, and then the device was irradiated with light for 20 min. The light source was an ultra-high-pressure mercury lamp USH-500D (by Ushio, Inc.), and the distance between the device and the light source was 20 cm. In the measurement of VHR-3, a decaying voltage was measured for 16.7 milliseconds. A composition having a large VHR-3 has a high stability to UV light. The value of VHR-3 is preferably 90% or more, and more preferably 95% or more.

11) Voltage Holding Ratio (VHR-4; Measured at 25° C.; %):

A TN device into which a sample was poured was heated in a thermostat at 80° C. for 500 hours, and then the stability to heat was evaluated by measuring the voltage holding ratio. In the measurement of VHR-4, the decaying voltage was measured for 16.7 milliseconds. A composition having a large VHR-4 has a high stability to heat.

12) Response Time (τ; Measured at 25° C.; Millisecond):

An LCD evaluation system Model LCD-5100 made by Otsuka Electronics Co., Ltd. was used for the measurement. The light source was a halogen lamp. The low-pass filter was set at 5 kHz. A sample was poured into a VA device having a normally black mode, in which the distance between the two glass substrates (cell gap) was 4 μm, and the rubbing direction was antiparallel. This device was sealed with a UV-curable adhesive. Rectangular waves (60 Hz, 10 V, 0.5 sec) were applied to this device. The device was vertically irradiated with light simultaneously, and the amount of light passing through the device was measured. The transmittance was regarded as 100% when the amount of light reached a maximum. The transmittance was regarded as 0% when the amount of light reached a minimum. The response time was expressed as the period of time required for the change from 90% to 10% transmittance (fall time: millisecond).

13) Specific Resistance (ρ; Measured at 25° C.; Ω·cm):

A sample of 1.0 mL was poured into a vessel equipped with electrodes. A DC voltage (10 V) was applied to the vessel, and the DC current was measured after 10 sec. The specific resistance ρ was calculated with the equation “ρ=[(voltage)×(electric capacity of vessel)]/[(DC current)×(dielectric constant in vacuum)].”

The compounds described in Examples were expressed in terms of symbols according to the definition in Table 3 described below. In Table 3, the configuration of 1,4-cyclohexylene is trans. The parenthesized number next to a symbolized compound in Examples corresponds to the number of the compound. The symbol “(−)” means any other liquid crystal compound. The proportion (percentage) of a liquid crystal compound means the weight percentage (wt %) based on the weight of the liquid crystal composition. Last, the values of characteristics of the composition are summarized.

TABLE 3
Method of Description of Compounds using Symbols
R—(A₁)—Z₁— . . . —Zₙ—(Aₙ)—R′

| | |
|---|---|
| 1) Left-terminal Group R— | Symbol |
| FCₙH₂ₙ— | Fn- |
| CₙH₂ₙ₊₁— | n- |
| CₙH₂ₙ₊₁O— | nO— |
| CₘH₂ₘ₊₁OCₙH₂ₙ— | mOn- |
| CH₂═CH— | V— |
| CₙH₂ₙ₊₁—CH═CH— | nV— |
| CH₂═CH—CₙH₂ₙ— | Vn- |
| CₘH₂ₘ₊₁—CH═CH—CₙH₂ₙ— | mVn- |
| CF₂═CH— | VFF— |
| CF₂═CH—CₙH₂ₙ— | VFFn- |
| CₘH₂ₘ₊₁CF₂CₙH₂ₙ— | m(CF2)n- |
| CH₂═CHCOO— | AC— |
| CH₂═C(CH₃)COO— | MAC— |
| 2) Right-terminal Group —R′ | Symbol |
| —CₙH₂ₙ₊₁ | -n |
| —OCₙH₂ₙ₊₁ | —On |
| —CH═CH₂ | —V |
| —CH═CH—CₙH₂ₙ₊₁ | —Vn |
| —CₙH₂ₙ—CH═CH₂ | -nV |
| —CₘH₂ₘ—CH═CH—CₙH₂ₙ₊₁ | -mVn |
| —CH═CF₂ | —VFF |
| —OCOCH═CH₂ | —AC |
| —OCOC(CH₃)═CH₂ | —MAC |
| 3) Bonding Group —Zₙ— | Symbol |
| —CₙH₂ₙ— | n |
| —COO— | E |
| —CH═CH— | V |
| —CH═CHO— | VO |
| —OCH═CH— | OV |
| —CH₂O— | 1O |
| —OCH₂— | O1 |
| 4) Ring —Aₙ— | Symbol |
| 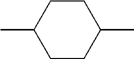 | H |
| 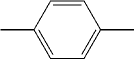 | B |
| 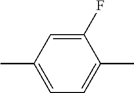 | B(F) |
| 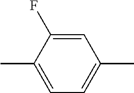 | B(2F) |
| 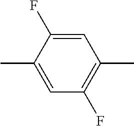 | B(2F,5F) |
| 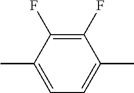 | B(2F,3F) |
| 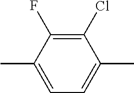 | B(2F,3Cl) |
| 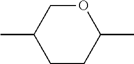 | dh |
| 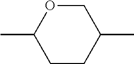 | Dh |
| 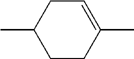 | ch |
| 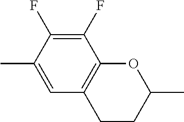 | Cro(7F,8F) |
| 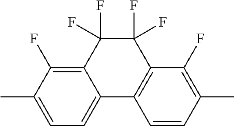 | Pnr(F6) |

5) Examples of Description

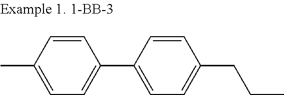 [SMILES: CCCc1ccc(-c2ccc(C)cc2)cc1]

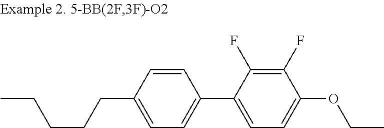 [SMILES: CCCCCc1ccc(-c2ccc(OCC)c(F)c2F)cc1]

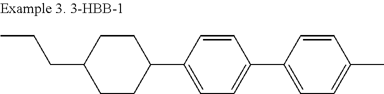 [SMILES: CCCC1CCC(c2ccc(-c3ccc(C)cc3)cc2)CC1]

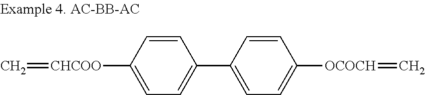

### Comparative Example 1

Example 10 was selected from the compositions disclosed in WO 2013/122011 A, because the composition thereof contained compounds (1), (2), (3), (4), (5-6) and (5-7) and the proportion of compound (1) was 8%. The components and the characteristics of the composition were as follows:

| | | |
|---|---|---|
| 1-BB-3 | (1) | 8% |
| 3-HH-V | (2) | 10% |
| 3-B(F)BB-2 | (3) | 3% |
| V-HHB-1 | (4) | 7% |
| V2-HHB-1 | (4) | 5% |
| 5-HH2B(2F,3F)-O2 | (5-6) | 7% |
| 5-HH1OB(2F,3F)-O2 | (5-7) | 5% |
| 3-HHB(2F,3CL)-O2 | (—) | 3% |
| 3-HH-V1 | (—) | 5% |
| 3-HH-2V1 | (—) | 3% |
| 3-HB-O1 | (—) | 5% |
| 2-BB(F)B-3 | (—) | 3% |
| F2-HB(2F,3F)-O2 | (—) | 5% |
| F3-HB(2F,3F)-O2 | (—) | 10% |
| F3-HHB(2F,3F)-O2 | (—) | 5% |
| F3-HBB(2F,3F)-O2 | (—) | 8% |
| 2(CF2)1-HHB(2F,3F)-O2 | (—) | 5% |
| 5-HDhB(2F,3F)-O2 | (—) | 3% |

NI = 85.6° C.; Tc < −20° C.; η = 20.9 mPa · s; Δn = 0.105; Δε = −3.1.

### Comparative Example 2

Example 1 was selected from the compositions disclosed in JP 2013-173915 A, because the composition thereof contained compounds (1), (2), (3), (4), (5-4), (5-5) and (5-7) and the proportion of compound (1) was 4%. The components and the characteristics of the composition were as follows:

| | | |
|---|---|---|
| 1-BB-3 | (1) | 4% |
| 3-HH-V | (2) | 28% |
| 5-B(F)BB-2 | (3) | 5% |
| 5-B(F)BB-3 | (3) | 3% |
| 3-HHB-1 | (4) | 3% |
| 3-HHB-3 | (4) | 3% |
| 3-BB(2F,3F)-O2 | (5-4) | 9% |
| 5-BB(2F,3F)-O2 | (5-4) | 5% |
| 3-H1OPnr(F6)-O2 | (—) | 7% |
| V-HHB(2F,3F)-O2 | (5-5) | 11% |
| 2-HH1OB(2F,3F)-O2 | (5-7) | 8% |
| 3-HH1OB(2F,3F)-O2 | (5-7) | 11% |
| 3-HDhB(2F,3F)-O2 | (—) | 3% |

NI = 79.6° C.; Tc < −20° C.; η = 27.3 mPa · s; Δn = 0.112; Δε = −3.3; Vth = 2.26 V.

### Comparative Example 3

Example 14 was selected from the compositions disclosed in WO 2012/144321 A, because the composition thereof contained compounds (1), (2), (3), (4), (5-4), (5-5), (5-7) and (5-8) and the proportion of compound (1) was 7%. The components and the characteristics of the composition were as follows:

| | | |
|---|---|---|
| 1-BB-3 | (1) | 7% |
| 3-HH-V | (2) | 15% |
| 5-B(F)BB-2 | (3) | 3% |
| 5-B(F)BB-3 | (3) | 3% |
| 3-HHB-1 | (4) | 3% |
| 3-BB(2F,3F)-O2 | (5-4) | 7% |
| 5-HHB(2F,3F)-O2 | (5-5) | 5% |
| V-HHB(2F,3F)-O2 | (5-5) | 5% |
| 2-HH1OB(2F,3F)-O2 | (5-7) | 7% |
| 3-HH1OB(2F,3F)-O2 | (5-7) | 5% |
| 4-HH1OB(2F,3F)-O2 | (5-7) | 5% |
| 2-BB(2F,3F)B-3 | (5-8) | 7% |
| 5-HH-V | (—) | 5% |
| F2-HH-V | (—) | 5% |
| F2-HH-V3 | (—) | 5% |
| F3-HH-V | (—) | 7% |
| 5-HB-O2 | (—) | 3% |
| 2-HDhB(2F,3F)-O2 | (—) | 3% |

NI = 72.2° C.; Tc < −30° C.; η = 16.1 mPa · s; Δn = 0.102; Δε = −3.2.

### Comparative Example 4

Example 9 was selected from the compositions disclosed in WO 2012/053323 A, because the composition thereof contained compounds (1), (2), (3), (5-4), (5-6), (5-7) and (5-9) and the proportion of compound (1) was 6%. The components and the characteristics of the composition were as follows:

| | | |
|---|---|---|
| 1-BB-3 | (1) | 6% |
| 1-BB-7 | (—) | 3% |
| 2-BB-3 | (—) | 4% |
| 3-BB-5 | (—) | 5% |
| 3-dhBB(2F,3F)-O2 | (—) | 4% |
| 5-DhB(2F,3F)-O2 | (—) | 6% |
| 3-HH-V | (2) | 5% |
| 3-HH-V1 | (—) | 5% |
| 3-HH-VFF | (—) | 5% |
| V2-BB(F)B-3 | (—) | 3% |
| 5-B(F)BB-2 | (3) | 5% |
| 3-HHEBH-3 | (—) | 3% |
| 5-HBB(F)B-2 | (—) | 3% |
| 8-BB(2F,3F)-O2 | (5-4) | 5% |
| 1V2-BB(2F,3F)-O2 | (5-4) | 5% |
| 3-HH2B(2F,3F)-O2 | (5-6) | 5% |
| 3-HH1OB(2F,3F)-O2 | (5-7) | 8% |
| 4-HH1OB(2F,3F)-O2 | (5-7) | 4% |
| 5-HH1OB(2F,3F)-O2 | (5-7) | 8% |
| V2-HBB(2F,3F)-O2 | (5-9) | 4% |
| 1V2-HBB(2F,3F)-O2 | (5-9) | 4% |

NI = 86.3° C.; Tc < −20° C.; η = 18.8 mPa · s; Δn = 0.131; Δε = −3.4.

### Comparative Example 5

Example 5 was selected from the compositions disclosed in WO 2012/046590 A, because the composition thereof contained compounds (1), (2), (4), (5-4), (5-6), (5-7) and (5-9) and the proportion of compound (1) was 8%. The components and the characteristics of the composition were as follows:

| | | |
|---|---|---|
| 1-BB-3 | (1) | 8% |
| 3-HH-V | (2) | 24% |
| 3-HBB-2 | (4) | 5% |
| 3-H2B(2F,3F)-O4 | (5-2) | 5% |
| 2-BB(2F,3F)-4 | (5-4) | 6% |
| 5-HH2B(2F,3F)-O2 | (5-6) | 10% |
| 5-HH1OB(2F,3F)-O2 | (5-7) | 8% |
| 5-HBB(2F,3F)-O2 | (5-9) | 8% |
| 1V2-HBB(2F,3F)-O2 | (5-9) | 3% |
| 3-HH-VFF | (—) | 2% |
| 1-HH-2V1 | (—) | 5% |
| 3-HHEH-5 | (—) | 4% |
| 3-H2Cro(7F,8F)-5 | (—) | 3% |
| 3-H1OCro(7F,8F)-5 | (—) | 3% |
| 3-HH1OCro(7F,8F)-5 | (—) | 6% |

NI = 83.7° C.; Tc < −20° C.; η = 18.5 mPa · s; Δn = 0.104; Δε = −3.1.

### Example 1

| | | |
|---|---|---|
| 1-BB-3 | (1) | 16% |
| 3-HH-V | (2) | 25% |
| 5-B(F)BB-2 | (3) | 4% |
| 5-B(F)BB-3 | (3) | 4% |
| V-HB(2F,3F)-O2 | (5-1) | 3% |
| 3-HB(2F,3F)-O2 | (5-1) | 4% |
| 5-H2B(2F,3F)-O2 | (5-2) | 4% |
| 3-HHB(2F,3F)-O2 | (5-5) | 5% |
| V2-HHB(2F,3F)-O2 | (5-5) | 3% |
| 2-HH1OB(2F,3F)-O2 | (5-7) | 5% |
| 3-HH1OB(2F,3F)-O2 | (5-7) | 13% |
| V-HH1OB(2F,3F)-O2 | (5-7) | 10% |
| 3-HchB(2F,3F)-O2 | (5-11) | 4% |

NI = 73. 6° C.; Tc < −20° C.; η = 14.4 mPa · s; Δn = 0.108; Δε = −3.2; Vth = 2.15 V; γ1 = 68.1 mPa · s.

### Example 2

| | | |
|---|---|---|
| 1-BB-3 | (1) | 15% |
| 3-HH-V | (2) | 25% |
| 5-B(F)BB-2 | (3) | 5% |
| 5-B(F)BB-3 | (3) | 4% |
| 3-HHB-3 | (4) | 3% |
| 3-HB(2F,3F)-O2 | (5-1) | 4% |
| 3-BB(2F,3F)-O2 | (5-4) | 6% |
| 3-HHB(2F,3F)-O2 | (5-5) | 10% |
| V-HHB(2F,3F)-O1 | (5-5) | 3% |
| V-HHB(2F,3F)-O4 | (5-5) | 11% |
| 3-HH1OB(2F,3F)-O2 | (5-7) | 8% |
| 2-BB(2F,3F)B-3 | (5-8) | 3% |
| 1O1-HBBH-5 | (—) | 3% |

NI = 80.0° C.; Tc < −20° C.; η = 14.0 mPa · s; Δn = 0.120; Δε = −2.2; Vth = 2.49 V; γ1 = 67.3 mPa · s.

### Example 3

| | | |
|---|---|---|
| 1-BB-3 | (1) | 16% |
| 3-HH-V | (2) | 33% |
| 5-B(F)BB-3 | (3) | 6% |
| 3-HB(2F,3F)-O2 | (5-1) | 4% |
| 3-BB(2F,3F)-O2 | (5-4) | 4% |
| 3-HHB(2F,3F)-O2 | (5-5) | 8% |
| V-HHB(2F,3F)-O1 | (5-5) | 4% |
| V-HHB(2F,3F)-O4 | (5-5) | 7% |
| 3-HH1OB(2F,3F)-O2 | (5-7) | 12% |
| V-HH1OB(2F,3F)-O2 | (5-7) | 6% |

NI = 70.9° C.; Tc < −20° C.; η = 11.3 mPa · s; Δn = 0.103; Δε = −2.8; Vth = 2.36 V; γ1 = 63.7 mPa · s.

### Example 4

| | | |
|---|---|---|
| 1-BB-3 | (1) | 13% |
| 3-HH-V | (2) | 36% |
| 5-B(F)BB-2 | (3) | 3% |
| 5-B(F)BB-3 | (3) | 3% |
| 2-B(F)BB-3 | (3) | 3% |
| 3-HBB-2 | (4) | 4% |
| 3-H2B(2F,3F)-O2 | (5-2) | 3% |
| 3-H1OB(2F,3F)-O2 | (5-3) | 8% |
| 3-HHB(2F,3F)-O2 | (5-5) | 8% |
| V-HHB(2F,3F)-O2 | (5-5) | 7% |
| 2-HBB(2F,3F)-O2 | (5-9) | 3% |
| 3-HBB(2F,3F)-O2 | (5-9) | 5% |
| V-HBB(2F,3F)-O2 | (5-9) | 4% |

NI = 71.1° C.; Tc < −20° C.; η = 10.9 mPa · s; Δn = 0.112; Δε = −2.1; Vth = 2.52 V; γ1 = 62.8 mPa · s.

### Example 5

| | | |
|---|---|---|
| 1-BB-3 | (1) | 14% |
| 3-HH-V | (2) | 32% |
| 5-B(F)BB-2 | (3) | 5% |
| 2-B(F)BB-3 | (3) | 5% |
| V-HHB-1 | (4) | 3% |
| V2-HHB-1 | (4) | 4% |
| 2O-BB(2F,3F)-O2 | (5-4) | 4% |
| 5-HH2B(2F,3F)-O2 | (5-6) | 4% |
| 3-HH1OB(2F,3F)-O2 | (5-7) | 11% |
| V-HH1OB(2F,3F)-O2 | (5-7) | 15% |
| 2-HH-3 | (—) | 3% |

NI = 76. 9° C.; Tc < −20° C.; η = 11.0 mPa · s; Δn = 0.110; Δε = −2.1; Vth = 2.51 V; γ1 = 63.1 mPa · s.

### Example 6

| | | |
|---|---|---|
| 1-BB-3 | (1) | 11% |
| 3-HH-V | (2) | 32% |
| 5-B(F)BB-3 | (3) | 5% |
| 2-B(F)BB-3 | (3) | 3% |
| V-HBB-2 | (4) | 3% |
| 3-H1OB(2F,3F)-O2 | (5-3) | 4% |
| V-H1OB(2F,3F)-O2 | (5-3) | 5% |
| 2-HHB(2F,3F)-O2 | (5-5) | 3% |
| V-HHB(2F,3F)-O1 | (5-5) | 6% |
| V-HHB(2F,3F)-O2 | (5-5) | 5% |
| 3-HH2B(2F,3F)-O2 | (5-6) | 3% |
| 2-HH1OB(2F,3F)-O2 | (5-7) | 5% |
| 3-HH1OB(2F,3F)-O2 | (5-7) | 9% |
| 2-BB(2F,3F)B-3 | (5-8) | 3% |
| 2-BB(2F,3F)B-4 | (5-8) | 3% |

NI = 73.2° C.; Tc < −20° C.; η = 12.9 mPa · s; Δn = 0.110; Δε = −2.7; Vth = 2.35 V; γ1 = 65.2 mPa · s.

### Example 7

| | | |
|---|---|---|
| 1-BB-3 | (1) | 10% |
| 3-HH-V | (2) | 43% |
| 5-B(F)BB-2 | (3) | 3% |
| 5-B(F)BB-3 | (3) | 3% |
| 3-HBB-2 | (4) | 3% |
| 5-H2B(2F,3F)-O2 | (5-2) | 4% |
| 3-H1OB(2F,3F)-O2 | (5-3) | 4% |
| V-HH1OB(2F,3F)-O2 | (5-7) | 9% |
| 2-BB(2F,3F)B-4 | (5-8) | 3% |
| 3-HBB(2F,3F)-O2 | (5-9) | 10% |
| V-HBB(2F,3F)-O2 | (5-9) | 5% |
| 3-HchB(2F,3F)-O2 | (5-11) | 3% |

NI = 71.4° C.; Tc < −20° C.; η = 9.5 mPa · s; Δn = 0.107; Δε = −2.3; Vth = 2.40 V; γ1 = 58.1 mPa · s.

### Example 8

| | | |
|---|---|---|
| 1-BB-3 | (1) | 15% |
| 3-HH-V | (2) | 30% |
| 5-B(F)BB-2 | (3) | 4% |
| 5-B(F)BB-3 | (3) | 9% |
| V-HBB-3 | (4) | 3% |
| V-H1OB(2F,3F)-O2 | (5-3) | 3% |
| 3-HHB(2F,3F)-O2 | (5-5) | 7% |
| V-HHB(2F,3F)-O4 | (5-5) | 10% |
| V-HH1OB(2F,3F)-O2 | (5-7) | 12% |
| 3-chB(2F,3F)-O2 | (5-10) | 4% |
| 3-HH-4 | (—) | 3% |

NI = 71.3° C.; Tc < −20° C.; η = 11.0 mPa · s; Δn = 0.113; Δε = −2.1; Vth = 2.50 V; γ1 = 64.0 mPa · s.

### Example 9

| | | |
|---|---|---|
| 1-BB-3 | (1) | 11% |
| 3-HH-V | (2) | 29% |
| 5-B(F)BB-2 | (3) | 4% |
| 5-B(F)BB-3 | (3) | 5% |
| V-HHB-1 | (4) | 4% |
| V2-HHB-1 | (4) | 5% |
| 3-H1OB(2F,3F)-O2 | (5-3) | 6% |
| 2-HHB(2F,3F)-O2 | (5-5) | 4% |
| V2-HHB(2F,3F)-O2 | (5-5) | 7% |
| 2-HH1OB(2F,3F)-O2 | (5-7) | 11% |
| 3-HBB(2F,3F)-O2 | (5-9) | 8% |
| V-HBB(2F,3F)-O2 | (5-9) | 6% |

NI = 86.2° C.; Tc < −20° C.; η = 14.0 mPa · s; Δn = 0.117; Δε = −2.3; Vth = 2.45 V; γ1 = 67.0 mPa · s.

### Example 10

| | | |
|---|---|---|
| 1-BB-3 | (1) | 10% |
| 3-HH-V | (2) | 34% |
| 5-B(F)BB-2 | (3) | 6% |
| 3-HHB-1 | (4) | 8% |
| 3-BB(2F,3F)-O2 | (5-4) | 5% |
| V2-BB(2F,3F)-O2 | (5-4) | 8% |
| 2-HH1OB(2F,3F)-O2 | (5-7) | 15% |
| 3-HH1OB(2F,3F)-O2 | (5-7) | 14% |

NI = 71.0° C.; Tc < −20° C.; η = 12.1 mPa · s; Δn = 0.103; Δε = −2.7; Vth = 2.34 V; γ1 = 64.7 mPa · s.

The compositions in Examples 1 to 10 had a small viscosity in comparison with those in Comparative Examples 1 to 5. Thus, it is concluded that the liquid crystal composition of the invention has excellent characteristics.

### INDUSTRIAL APPLICABILITY

The liquid crystal composition of the invention satisfies at least one of characteristics such as a high maximum temperature, a low minimum temperature, a small viscosity, a suitable optical anisotropy, a large negative dielectric anisotropy, a large specific resistance, a high stability to UV light and a high stability to heat, or is suitably balanced between at least two of the characteristics. An LCD device comprising such a composition can be used for a liquid crystal projector, a liquid crystal television and so forth, as having characteristics such as a short response time, a large voltage holding ratio, a low threshold voltage, a large contrast ratio and a long service life.

It will be apparent to those skilled in the art that various modifications and variations can be made in the invention and specific examples provided herein without departing from the spirit or scope of the invention. Thus, it is intended that the invention covers the modifications and variations of this invention that come within the scope of any claims and their equivalents.

1. A liquid crystal composition, having a negative dielectric anisotropy, and comprising a compound represented by formula (1) as a first component, a compound represented by formula (2) as a second component, and at least one compound selected from the group consisting of compounds represented by formula (3) as a third component, wherein a proportion of the first component is in a range of 10 wt % to 25 wt % based on a weight of the liquid crystal composition: 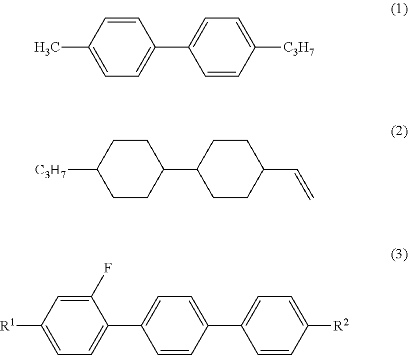
and in formula (3), R¹ and R² are independently alkyl having 1 to 12 carbons, alkoxy having 1 to 12 carbons or alkenyl having 2 to 12 carbons.

2. The liquid crystal composition of claim 1, wherein a proportion of the second component is in a range of 10 wt % to 60 wt % and a proportion of the third component is in a range of 5 wt % to 25 wt %, based on the weight of the liquid crystal composition.

3. The liquid crystal composition of claim 1, further comprising at least one compound selected from the group consisting of compounds represented by formula (4) as a fourth component: 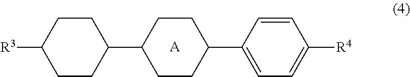
wherein in formula (4), R³ and R⁴ are independently alkyl having 1 to 12 carbons, alkoxy having 1 to 12 carbons or alkenyl having 2 to 12 carbons, and ring A is 1,4-cyclohexylene or 1,4-phenylene.

4. The liquid crystal composition of claim 3, wherein a proportion of the fourth component is in a range of 5 wt % to 25 wt % based on the weight of the liquid crystal composition.

5. The liquid crystal composition of claim 1, further comprising at least one compound selected from the group consisting of compounds represented by formula (5) as a fifth component: 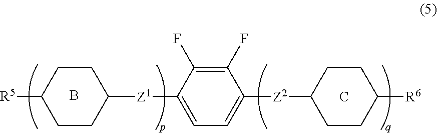
wherein in formula (5), R⁵ and R⁶ are independently alkyl having 1 to 12 carbons, alkoxy having 1 to 12 carbons or alkenyl having 2 to 12 carbons; ring B and ring C are independently 1,4-cyclohexylene, 1,4-cyclohexenylene, 1,4-phenylene, or 1,4-phenylene in which at least one hydrogen has been replaced by fluorine or chlorine; Z¹ and Z² are independently a single bond, ethylene, carbonyloxy or methyleneoxy; p is 1, 2 or 3; q is 0 or 1; and the sum of p and q is 3 or less.

6. The liquid crystal composition of claim 3, further comprising at least one compound selected from the group consisting of compounds represented by formula (5) as a fifth component: 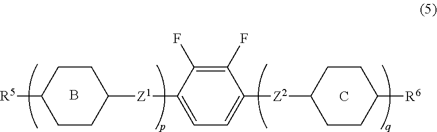
wherein in formula (5), R⁵ and R⁶ are independently alkyl having 1 to 12 carbons, alkoxy having 1 to 12 carbons or alkenyl having 2 to 12 carbons; ring B and ring C are independently 1,4-cyclohexylene, 1,4-cyclohexenylene, 1,4-phenylene, or 1,4-phenylene in which at least one hydrogen has been replaced by fluorine or chlorine; Z¹ and Z² are independently a single bond, ethylene, carbonyloxy or methyleneoxy; p is 1, 2 or 3; q is 0 or 1; and the sum of p and q is 3 or less.

7. The liquid crystal composition of claims, wherein the fifth component comprises at least one compound selected from the group consisting of compounds represented by formula (5-1) to formula (5-11): 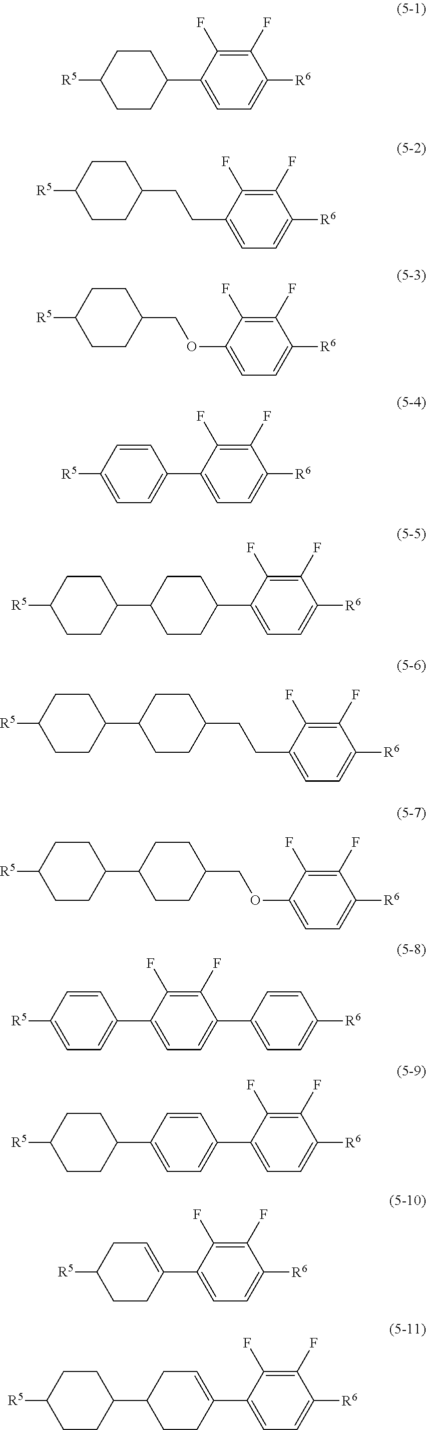
and in formula (5-1) to formula (5-11), R⁵ and R⁶ are independently alkyl having 1 to 12 carbons, alkoxy having 1 to 12 carbons or alkenyl having 2 to 12 carbons.

8. The liquid crystal composition of claim 6, wherein the fifth component comprises at least one compound selected from the group consisting of compounds represented by formula (5-1) to formula (5-11): 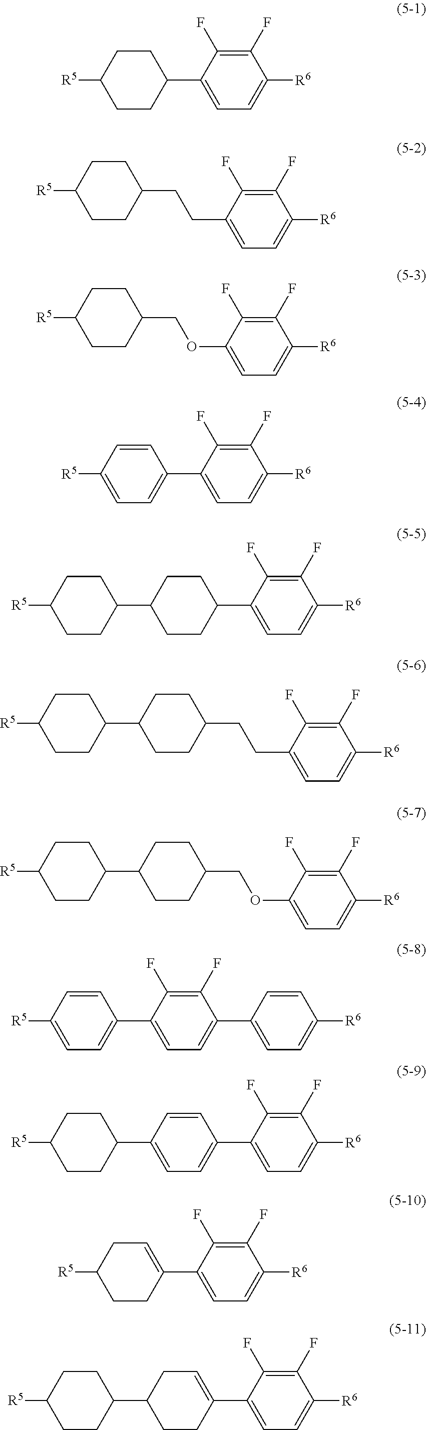
and in formula (5-1) to formula (5-11), R⁵ and R⁶ are independently alkyl having 1 to 12 carbons, alkoxy having 1 to 12 carbons or alkenyl having 2 to 12 carbons.

9. The liquid crystal composition of claim 5, wherein a proportion of the fifth component is in a range of 15 wt % to 70 wt % based on the weight of the liquid crystal composition.

10. The liquid crystal composition of claim 1, further comprising at least one polymerizable compound selected from the group consisting of compounds represented by formula (6) as an additive component: 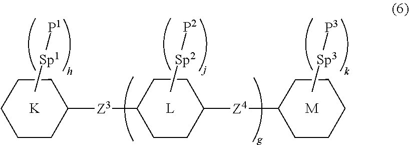
wherein in formula (6),
ring K and ring M are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in these rings at least one hydrogen may be replaced by fluorine, chlorine, alkyl having 1 to 12 carbons, alkoxy having 1 to 12 carbons, or alkyl having 1 to 12 carbons in which at least one hydrogen has been replaced by fluorine or chlorine;
ring L is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in these rings at least one hydrogen may be replaced by fluorine, chlorine, alkyl having 1 to 12 carbons, alkoxy having 1 to 12 carbons, or alkyl having 1 to 12 carbons in which at least one hydrogen has been replaced by fluorine or chlorine;
Z³ and Z⁴ are independently a single bond or alkylene having 1 to 10 carbons, and in this alkylene at least one —CH₂— may be replaced by —O—, —CO—, —COO— or —OCO—, and at least one —CH₂—CH₂— may be replaced by —CH═CH—, —C(CH₃)═CH—, —CH═C(CH₃)— or —C(CH₃)═C(CH₃)—, and in these groups at least one hydrogen may be replaced by fluorine or chlorine;
P¹, P² and P³ are independently a polymerizable group;
Sp¹, Sp² and Sp³ are independently a single bond or alkylene having 1 to 10 carbons, and in this alkylene at least one —CH₂— may be replaced by —O—, —COO—, —OCO— or —OCOO—, and at least one —CH₂—CH₂— may be replaced by —CH═CH— or —C≡C—, and in these groups at least one hydrogen may be replaced by fluorine or chlorine;
g is 0, 1 or 2;
h, j and k are independently 0, 1, 2, 3 or 4; and
the sum of h, j and k is 1 or more.

11. The liquid crystal composition of claim 3, further comprising at least one polymerizable compound selected from the group consisting of compounds represented by formula (6) as an additive component: 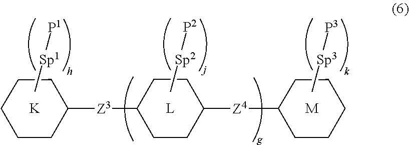
wherein in formula (6),
ring K and ring M are independently cyclohexyl, cyclohexenyl, phenyl, 1-naphthyl, 2-naphthyl, tetrahydropyran-2-yl, 1,3-dioxane-2-yl, pyrimidine-2-yl or pyridine-2-yl, and in these rings at least one hydrogen may be replaced by fluorine, chlorine, alkyl having 1 to 12 carbons, alkoxy having 1 to 12 carbons, or alkyl having 1 to 12 carbons in which at least one hydrogen has been replaced by fluorine or chlorine;
ring L is 1,4-cyclohexylene, 1,4-cyclohexenylene, 1,4-phenylene, naphthalene-1,2-diyl, naphthalene-1,3-diyl, naphthalene-1,4-diyl, naphthalene-1,5-diyl, naphthalene-1,6-diyl, naphthalene-1,7-diyl, naphthalene-1,8-diyl, naphthalene-2,3-diyl, naphthalene-2,6-diyl, naphthalene-2,7-diyl, tetrahydropyran-2,5-diyl, 1,3-dioxane-2,5-diyl, pyrimidine-2,5-diyl or pyridine-2,5-diyl, and in these rings at least one hydrogen may be replaced by fluorine, chlorine, alkyl having 1 to 12 carbons, alkoxy having 1 to 12 carbons, or alkyl having 1 to 12 carbons in which at least one hydrogen has been replaced by fluorine or chlorine;
Z³ and Z⁴ are independently a single bond or alkylene having 1 to 10 carbons, and in this alkylene at least one —CH₂— may be replaced by —O—, —CO—, —COO— or —OCO—, and at least one —CH₂—CH₂— may be replaced by —CH═CH—, —C(CH₃) ═CH—, —CH═C(CH₃)— or —C(CH₃)═C(CH₃)—, and in these groups at least one hydrogen may be replaced by fluorine or chlorine;
P¹, P² and P³ are independently a polymerizable group;
Sp¹, Sp² and Sp^{a} are independently a single bond or alkylene having 1 to 10 carbons, and in this alkylene at least one —CH₂— may be replaced by —O—, —COO—, —OCO— or —OCOO—, and at least one —CH₂—CH₂— may be replaced by —CH═CH— or —C≡C—, and in these groups at least one hydrogen may be replaced by fluorine or chlorine;
g is 0, 1 or 2;
h, j and k are independently 0, 1, 2, 3 or 4; and
the sum of h, j and k is 1 or more.

12. The liquid crystal composition of claim 10, wherein in formula (6), P¹, P² and P³ are independently a polymerizable group selected from the group consisting of groups represented by formula (P-1) to formula (P-5): 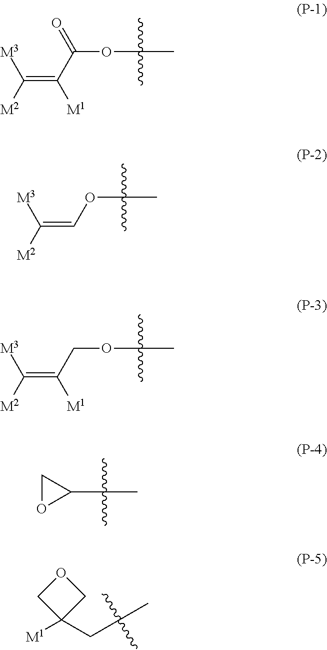
and in formula (P-1) to formula (P-5), M¹, M² and M³ are independently hydrogen, fluorine, alkyl having 1 to 5 carbons, or alkyl having 1 to 5 carbons in which at least one hydrogen has been replaced by fluorine or chlorine.

13. The liquid crystal composition of claim 11, wherein in formula (6), P¹, P² and P³ are independently a polymerizable group selected from the group consisting of groups represented by formula (P-1) to formula (P-5): 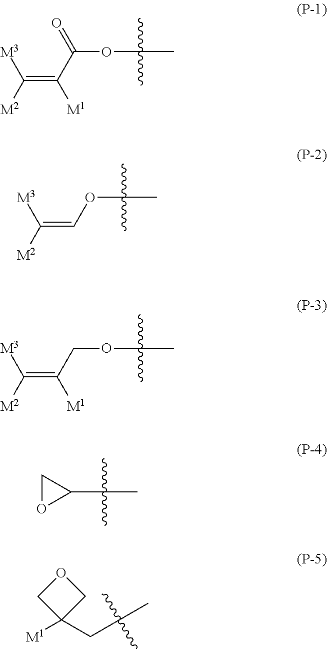
and in formula (P-1) to formula (P-5), M¹, M² and M³ are independently hydrogen, fluorine, alkyl having 1 to 5 carbons, or alkyl having 1 to 5 carbons in which at least one hydrogen has been replaced by fluorine or chlorine.

14. The liquid crystal composition of claim 10, wherein the additive component comprises at least one polymerizable compound selected from the group consisting of compounds represented by formula (6-1) to formula (6-27): 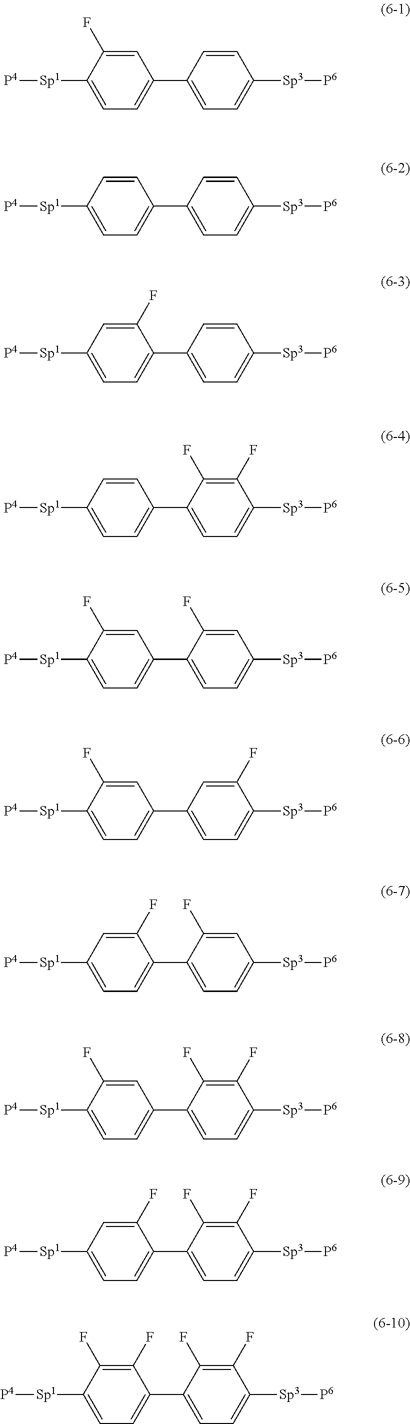 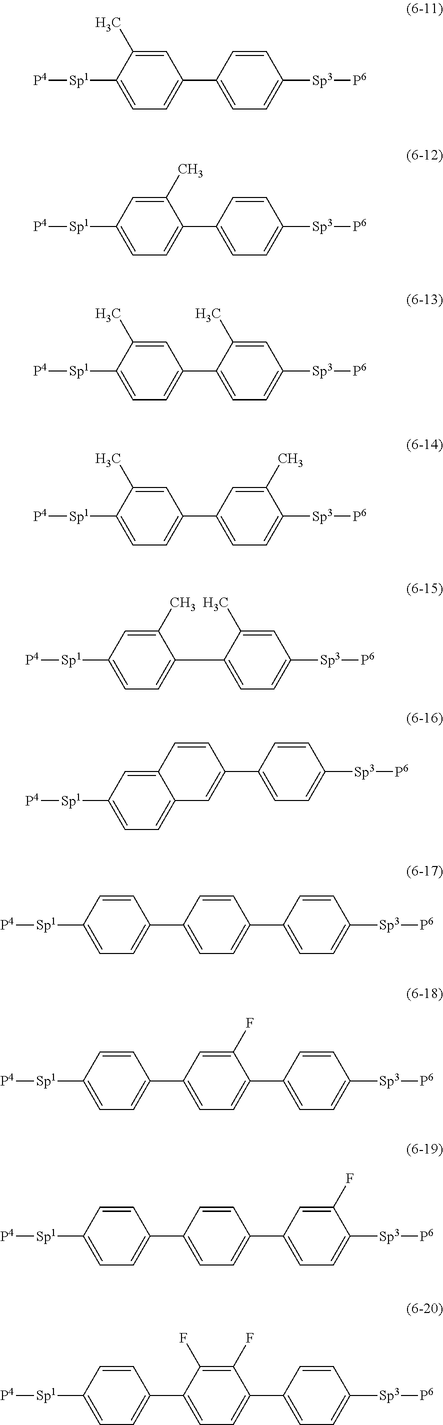 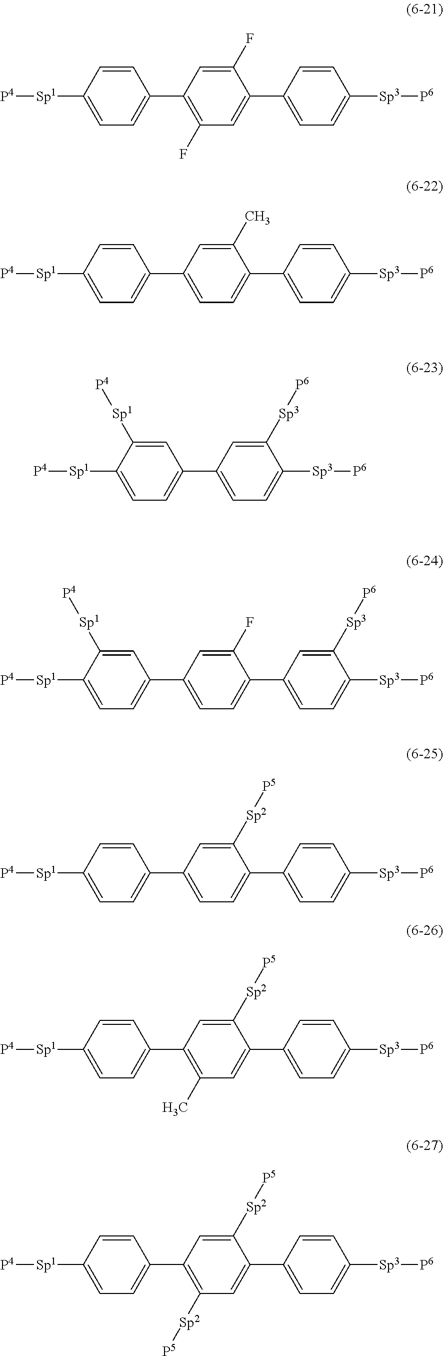
in formula (6-1) to formula (6-27), P⁴, P⁵ and P⁶ are independently a polymerizable group selected from the group consisting of groups represented by formula (P-1) to formula (P-3); 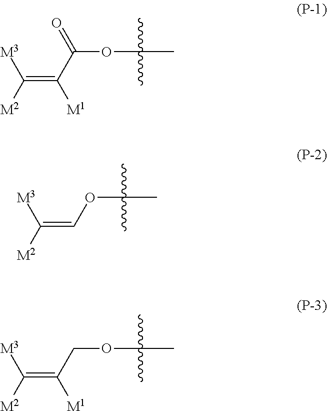
in formula (P-1) to formula (P-3), M¹, M² and M³ are independently hydrogen, fluorine, alkyl having 1 to 5 carbons, or alkyl having 1 to 5 carbons in which at least one hydrogen has been replaced by fluorine or chlorine; and
in formula (6-1) to formula (6-27), Sp¹, Sp² and Sp^{a} are independently a single bond or alkylene having 1 to 10 carbons, and in this alkylene at least one —CH₂— may be replaced by —O—, —OCO—, —OCO— or —OCOO—, and at least one —CH₂—CH₂— may be replaced by —CH═CH— or —C≡C—, and in these groups at least one hydrogen may be replaced by fluorine or chlorine.

15. The liquid crystal composition of claim 11, wherein the additive component comprises at least one polymerizable compound selected from the group consisting of compounds represented by formula (6-1) to formula (6-27): 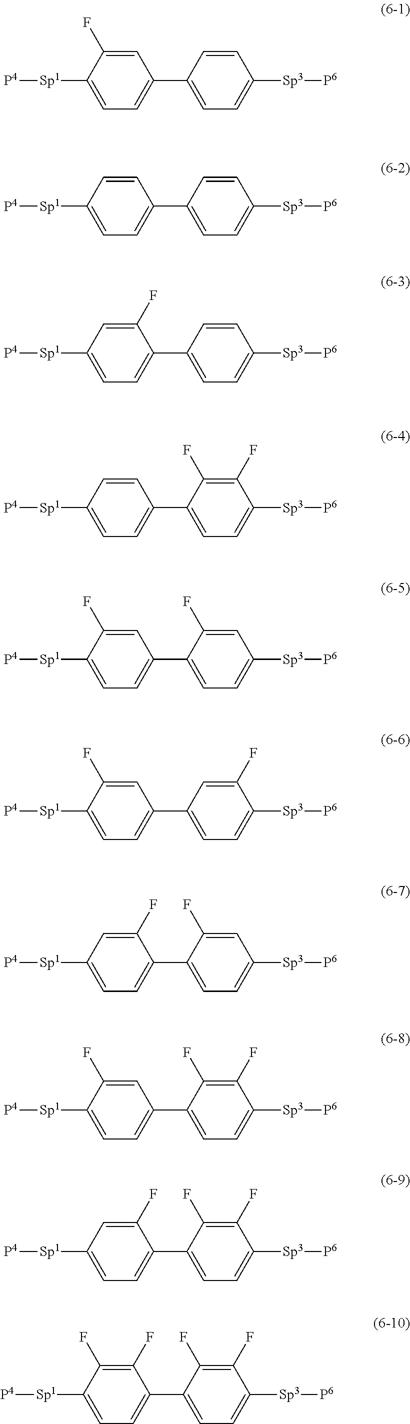 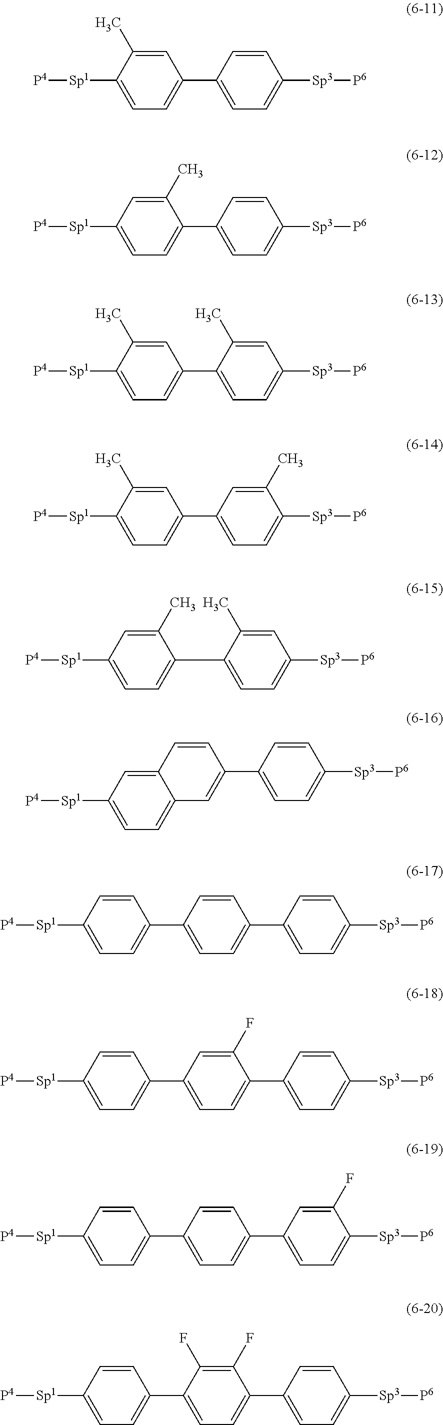 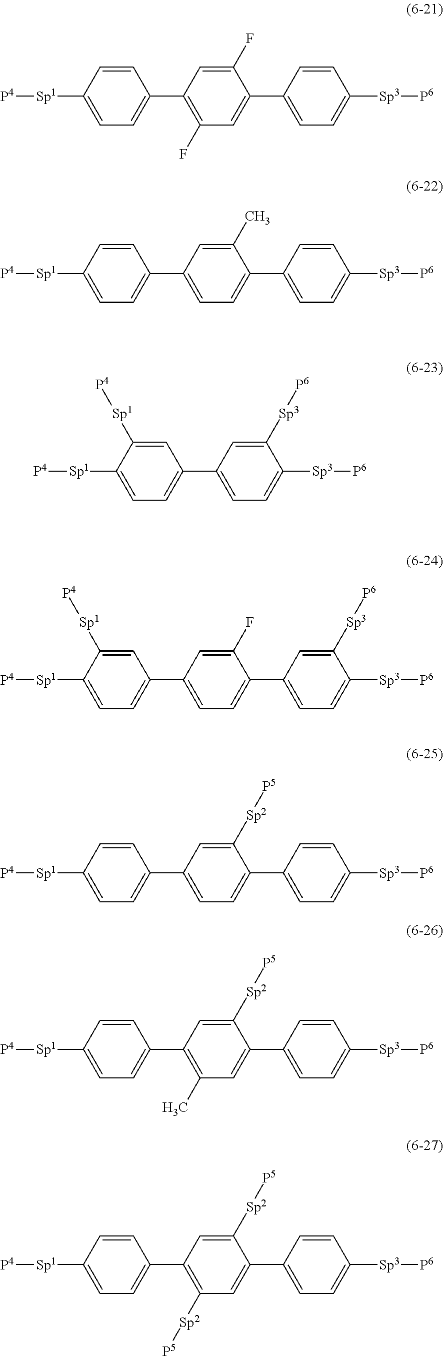
in formula (6-1) to formula (6-27), P⁴, P⁵ and P⁶ are independently a polymerizable group selected from the group consisting of groups represented by formula (P-1) to formula (P-3); 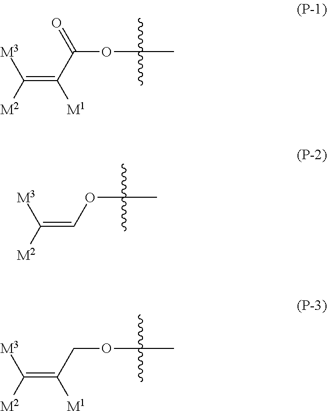
in formula (P-1) to formula (P-3), M¹, M² and M³ are independently hydrogen, fluorine, alkyl having 1 to 5 carbons, or alkyl having 1 to 5 carbons in which at least one hydrogen has been replaced by fluorine or chlorine; and
in formula (6-1) to formula (6-27), Sp¹, Sp² and Sp³ are independently a single bond or alkylene having 1 to 10 carbons, and in this alkylene at least one —CH₂— may be replaced by —O—, —OCO—, —OCO— or —OCOO—, and at least one —CH₂—CH₂— may be replaced by —CH═CH— or —C≡C—, and in these groups at least one hydrogen may be replaced by fluorine or chlorine.

16. The liquid crystal composition of claim 10, wherein a proportion of the additive component is in a range of 0.03 wt % to 10 wt % based on the weight of the liquid crystal composition.

17. A liquid crystal display device comprising the liquid crystal composition of claim 1.

18. The liquid crystal display device of claim 17, of which an operating mode is an IPS mode, a VA mode, an FFS mode or an FPA mode, and a driving mode is an active matrix mode.

19. A liquid crystal display device of a polymer sustained alignment type, comprising the liquid crystal composition of claim 10 in which the polymerizable compound in the liquid crystal composition has been polymerized.
